(19) United States
(12) Patent Application Publication
(10) Pub. No.: US 2009/0037247 A1
(43) Pub. Date: Feb. 5, 2009

(54) METHOD AND SYSTEM FOR MANAGING LEGAL MATTERS

(76) Inventor: Thomas Frederick Quinn, Lexington, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/282,679

(22) PCT Filed: Mar. 15, 2007
(86) PCT No.: PCT/US07/64062

§ 371 Date: Sep. 12, 2008

Related U.S. Application Data
(60) Provisional application No. 60/784,078, filed on Mar. 17, 2006.
(60) Provisional application No. 60/829,201, filed on Oct. 12, 2006.
(60) Provisional application No. 60/870,630, filed on Dec. 19, 2006.

(51) Int. Cl. G06Q 10/00; G06Q 50/00

(52) U.S. Cl. 705/8; 705/30

(57) ABSTRACT

This invention generally relates to a system and method for managing legal services as well as legal matters, assets, expenses and/or invoices and more particularly relates to a computer assisted system that stores, organizes and/or performs operations on data relating to legal services, legal matters, assets, costs, invoices and the like allowing a user of the system to search, sort, report, track, docket, sum, average and/or perform other operations on this data to generate legal service performance review reports, invoice review reports and/or various expense reports as well as calculate accounts payable, calculate inter-company charges and/or otherwise may manage the same by identifying internal and legal service provider inefficiencies and by identifying unnecessary and excessively priced services and expenses.

### CROSS-REFERENCE TO RELATED APPLICATIONS

This application claims the benefit of U.S. Provisional Application No. 60/784,078, filed on Mar. 17, 2006, U.S. Provisional Application No. 60/829,201, filed on Oct. 12, 2006, and U.S. Provisional Application No. 60/870,630, filed on Dec. 19, 2006, the disclosures of which are incorporated herein by reference.

### FIELD OF THE INVENTION

This invention generally relates to a system and method for managing legal services as well as legal matters, assets, costs and invoices.

### BACKGROUND OF THE INVENTION

Unfortunately, many companies have suffered negative consequences in the legal system, making them acutely aware of the importance of properly managed legal matters and assets. Legal assets such as commercial agreements, government agreements, partnerships, patents, proprietary information, and the enforcement of the same, are quite often necessary for survival in today's corporate world.

When attorneys work on a company's legal matters, these matters and the legal assets that ultimately result from them should be carefully managed to ensure they are correctly processed. Critical dates, payments, deadlines and other requirements should be tracked in a reliable system to avoid penalties, loss of rights and/or the assets themselves. The quality of the legal service provided is also of utmost importance.

Furthermore, in today's global economy where companies are under tremendous pressure to reduce costs and increase profits, business leaders are in desperate need of a system to manage the rapidly increasing cost of these legal services. Legal systems in all countries are unique and tend to be very complex. Typically, business leaders have not practiced law and therefore find many of the required legal services to be incomprehensible. Business leaders are often left to believe that legal professional services are simply unmanageable from a cost perspective.

Companies desire an analytical legal management system that streamlines and integrates the internal management of legal services and their associated costs—a tool that analyzes legal invoice data and provides meaningful feedback that would enable them to manage growing legal costs. Moreover, companies desire a system that can be integrated with their current accounting and business systems so that manual re-entry of data is greatly reduced, existing company departments are integrated and linked, and the flow of legal cost data is streamlined through these departments.

Without such a system, business managers are at the mercy of law firms to guide them through esoteric legal processes, trusting that their services are efficient and of an appropriate professional quality, and that the resultant fees are fair and equitable. As a consequence, legal costs have soared in the corporate world, largely unmanaged, allowing inefficient and/or unscrupulous lawyers to charge excessively and/or overreach in their invoices without being detected. Moreover, when invoice amounts are high, inadvertent invoicing mistakes can also add up to be a significant cost.

### SUMMARY OF THE INVENTION

The present invention includes a computer assisted method and system with software that stores, organizes, analyzes, generates reports on and/or performs operations on data relating to legal services, legal matters, assets, costs, invoices and the like to help a business properly manage the same. One aspect of the present invention is an organizational tool that provides conventional matter management and docketing functions for legal matters and assets. Another aspect of the present invention is a cost optimization tool that helps businesses manage their in-house and outside legal services and all associated spending.

Yet another aspect of the present invention is as a system that generates reports identifying legal matters which have unauthorized, inaccurate, unnecessary and/or excessive charges and therefore require review. Users of the system can review these reports as well as the legal service providers' invoices, and enter their analysis and comments into the system. The system then compiles detailed reports that summarize invoice data for each legal matter at issue, as well as any analysis and comments applicable to that matter. With the historical invoice data neatly summarized for each legal matter in question, along with the relevant comments and analysis, these detailed reports can enable a manager to quickly review each open issue and manage the underlying costs and legal services. These reports can be readily used to conduct monthly invoice reviews for cost and/or service issues requiring immediate attention. Reports can also be used to conduct periodic performance reviews on legal service providers. As such, stacks of invoices can be readily converted into summary reports that identify the problems and offer recommended solutions, enabling businesses to aggressively manage legal costs.

In one aspect of the present invention is that it can provide immediate savings on legal matters by detecting mistakes, enforcing billing guidelines and identifying non-value added legal services. Short term savings can be generated by detecting overcharges in legal invoices and by identifying and assisting in the management of non-performing and overreaching attorneys. Long term savings are achieved by providing periodic and/or historical invoice review and performance review reports. These reports enable users to proactively manage legal service providers with detailed, documented information. Another aspect of the present invention further provides long term savings by calculating and comparing average charges for legal services, which allows an analytical user to review legal service quality and determine the best service value for the amount charged. After preferred suppliers are identified, work can be redirected and volume discounts can be used to gain further savings.

In various aspects of the present invention, the system can be operated on a personal computer, a server, an internal network of computers, via a web based application or other conventional remote or internet based systems. The present invention may include software that allows a user of the system to search, sort and report the data at their desktop computer. In another embodiment, users can enter and track docketing information for legal assets including but not limited to intellectual property, agreements and the like. The present invention may further include software that allows a legal service provider to convert invoice data into an electronic format that conforms to the system's requirements. In one aspect of the present invention, a user can use the software to transmit data to a third party. In another aspect, a user receives data and analyzes it. In yet another aspect of the present invention the software is used to analyze cost data including but not limited to tracking, averaging and comparing legal expenses and attorney fees to cost standards and budgets.

In another aspect, the present invention is compliant with other matter management software as well as various accounting software and the like. Moreover, detailed expense reports, invoice review reports and performance review reports can be immediately available from the present invention and can be categorized by and include numerous data fields including but not limited to date range, matter reference number, service type, region, law firm, attorney, technology, division, business unit, matter type, matter status, expense type, key words, comments, analysis, and the like.

### DESCRIPTION OF THE DRAWINGS

FIGS. 1A and 1B are of a flow chart depicting one embodiment of the present invention.

FIGS. 1C and 1D are of a flow chart depicting another embodiment of the present invention shown in FIGS. 1A and 1B.

FIG. 2 is flow chart depicting another embodiment of the present invention.

FIG. 3 is a depiction of a menu used by a business user to select a task to be performed in one embodiment of the present invention.

FIG. 4 is a depiction of a menu used by a business user to search, sort and report legal matter data in one embodiment of the present invention.

FIG. 5 is a depiction of a menu used by a business user to enter legal matter data in one embodiment of the present invention.

FIG. 6 is a depiction of a menu used by a legal service provider to select a task to be performed in one embodiment of the present invention.

FIG. 7 is a depiction of a menu used by a legal service provider to enter invoice data in one embodiment of the present invention.

FIG. 8A is a depiction of a first portion of a menu used to select a task to be performed in an embodiment of the present invention.

FIG. 8B is a depiction of a second portion of a menu used to select a task to be performed in an embodiment of the present invention.

FIG. 8C is a depiction of a third portion of a menu used to select a task to be performed in an embodiment of the present invention.

FIG. 9A is an exemplary report generated by the system illustrating a violation of guidelines in accordance with the present invention.

FIG. 9B is another exemplary report generated by the system illustrating a violation of guidelines in accordance with the present invention.

FIG. 10 is an exemplary report generated by the system illustrating charges exceeding the standard charge for a service type in accordance with the present invention.

FIG. 11 is an exemplary report generated by the system illustrating total charges compared to a legal matter budget in accordance with the present invention.

FIG. 12 is an exemplary report generated by the system illustrating the calculation of a volume discount for a legal invoice in accordance with the present invention.

FIG. 13 is an exemplary report generated by the system illustrating invoice data summed and grouped by business budget data in accordance with the present invention.

FIG. 14 is an exemplary report generated by the system illustrating invoice data summed by legal matter and grouped by business budget data in accordance with the present invention.

FIG. 15 is an exemplary report generated by the system illustrating adjustments to invoice data in accordance with the present invention.

FIG. 16 is an exemplary report generated by the system in accordance with the present invention summarizing invoice data for legal matters, along with the relevant comments and analysis.

FIG. 17 is an exemplary report generated by the system in accordance with the present invention summarizing a statistical analysis of charges by legal service providers for certain service types.

FIG. 18 is an exemplary invoice summary sheet generated by the system of the present invention summarizing a number of invoices received from one legal service provider.

FIG. 19 is an exemplary detailed invoice generated by the system of the present invention illustrating charges for legal matters.

### DETAILED DESCRIPTION OF THE INVENTIONS

Various aspects of the method and system of the present invention disclosed herein, along with the accompanying drawings referenced herein, are intended to be exemplary and not limiting. It is understood that other embodiments may be utilized and fall within the scope of the appended claims without departing from the spirit of the invention.

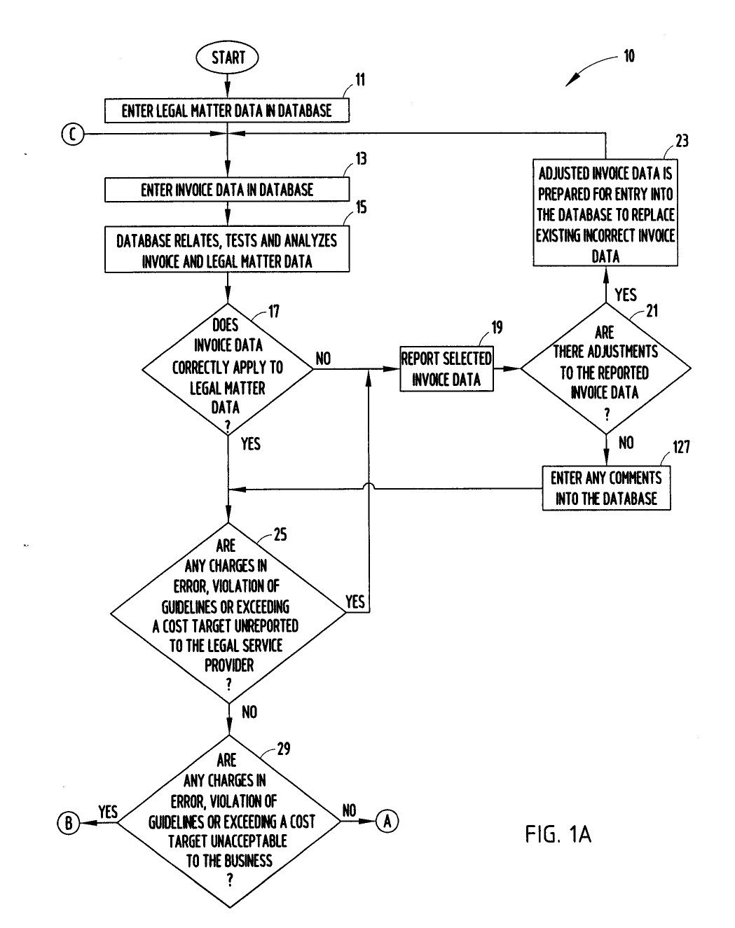

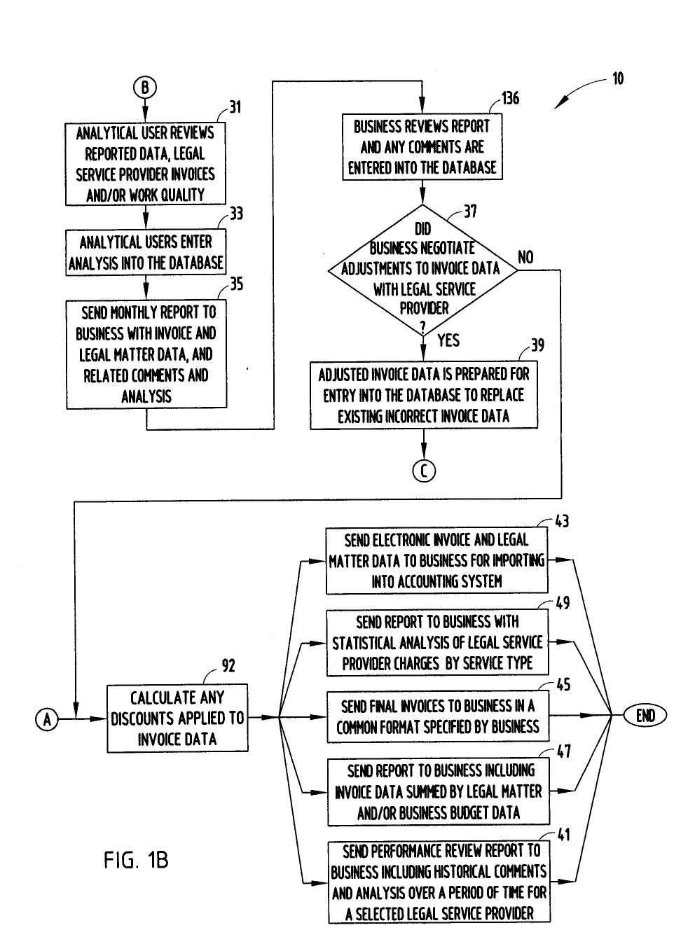

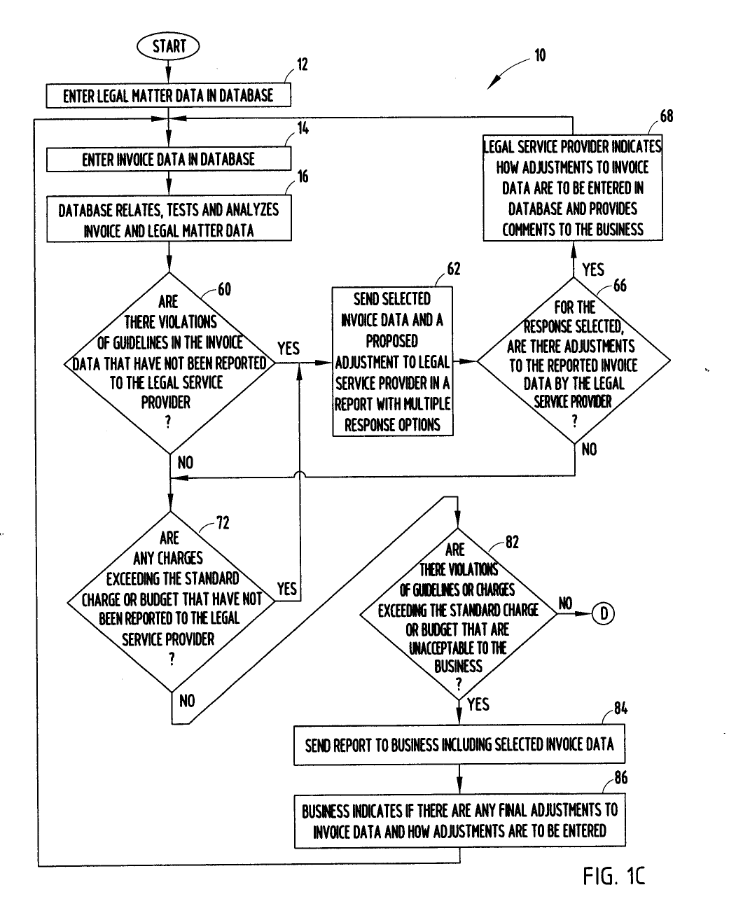

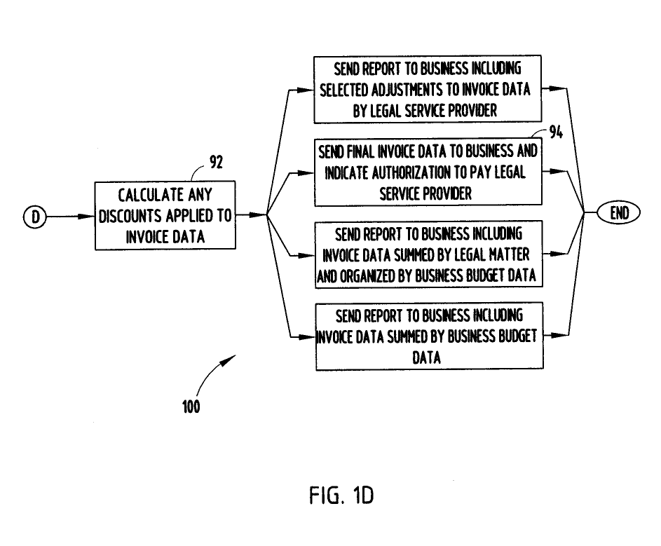

As shown in FIGS. 1A and 1B, a comprehensive method and database system 10 is provided that enables a business to manage its legal services, matters and assets, as well as the costs associated with them. A brief overview of how the method and database system of the present invention can be used is provided herein below, followed by more specific descriptions of various aspects.

In this system 10, business data relating to legal matters and assets is entered 11 into a database system, where it is stored and organized. Invoice data relating to these matters and assets is entered 13 into the database system 10, where it is related, tested and analyzed 15. After entry of the invoice data, the system applies a first series of tests 17 that identify if invoice data has been incorrectly stated by a legal service provider. For example, the system detects if charges relating to certain legal matters have incorrect matter reference numbers, countries, service types or expense types. These issues are reported 19, reviewed 21 and corrected 23 by users of the system.

Once corrected, the system then applies a second series of tests 25 to the invoice data that identify invoice mistakes, violations of billing guidelines and excessive charges. For example, the present invention compares total charges for standard services against agreed targets and total charges for unique services against agreed budgets. These total charges are cumulative and include all charges from all invoices currently or previously entered into the database system. Accordingly, targets and budgets are set and entered into the database system and when charges exceed these targets and budgets, the system generates reports 19 for review. Reports for excessive charges, as well as mistakes and violations of guidelines, are reviewed 21 by the legal service providers and their comments 127 and/or adjustments 23 are entered into the system.

If charges remain in question 29, these reports and comments can be quickly reviewed 31 by analytical users of the system. Legal service provider invoices and/or work quality can also be reviewed by analytical users of the system. This analytical review is to identify any underlying internal or external inefficiencies as well as inappropriate billing. Analytical users enter 33 their relevant analysis and comments into the system, along with any other analysis and/or comments relating to services or charges that were reviewed. The system then compiles 35 detailed reports that summarize invoice data for each legal matter at issue, as well as any analysis and comments applicable to the charges in question.

With the historical invoice data neatly summarized for each legal matter in question, along with the relevant comments and analysis, these detailed reports enable a manager to quickly review 136 each open issue and manage 37 the underlying costs and legal services. Any resulting adjustments 39 can be entered 13 into the database. These reports can also be readily used to conduct monthly invoice reviews for all legal service providers, where cost and/or service issues require immediate attention. Reports can also be generated to conduct periodic performance reviews 41 on specific legal service providers. Hence, a user of the system of the present invention can proactively manage both invoice charges and the performance of legal service providers with documented specificity.

Moreover, the system of the present invention can further reduce business costs by eliminating manual re-entry of invoice and legal matter data. Typically, invoice data is manually entered into an accounts payable software to generate checks for payment of invoices. In addition, invoice and legal matter data may also have to be entered into an e-billing, inter-company charges or auditing software. In any case, the database system of the present invention can categorize and download selected electronic invoice and legal matter data 43. This data can then be directly uploaded into these various software packages, without manual reentry.

In summary, the present invention is a tool that helps businesses manage their outside legal services and associated spending, by identifying unauthorized, inaccurate, unnecessary and excessive charges. The database system can be capable of relating, testing and analyzing the combined legal matter and invoice data. A user of the system may perform operations on the data including but not limited to searching, sorting, reporting, tracking, docketing, summing, averaging, calculating accounts payable, calculating inter-company charges, generating invoice review reports 35, generating legal service provider performance review reports 41, generating detailed invoices 45 with both legal matter and invoice data in a common format, generating business reports 47 including invoice data summed by legal matter and/or business budget data, and the like. The present invention further calculates average charges for discrete services 49 such that expensive and overreaching attorneys and law firms are identified as well as star attorneys and law firms. As such stacks of invoices can be easily converted into summary reports that identify the problems and offer recommended solutions, enabling businesses to aggressively manage legal costs.

Various embodiments of this system will be disclosed in greater detail herein below.

In one embodiment of the present invention, the business that owns legal matters and assets subscribes to an outside service, which manages the method and database system of the present invention. The goal of the outside service includes but is not limited to reducing the business' costs, reducing the amount time necessary to review invoices, providing a mechanism to conduct invoice reviews and conduct performance reviews on legal service providers, improving the flow and organization of invoice and legal matter data, improving internal business efficiencies and legal service provider efficiencies by assisting in the management thereof, and the like. If desired, the database system of the present invention could also be licensed by the outside service to the business and the business could be trained to operate the system in house.

In short, this outside service uses the method and database system of the present invention to store and organize legal matter and asset data as well as store, organize and manage the flow of invoice data from receipt of the invoice through payment. The outside service analyzes this data and enters comments and analysis that relate to invoice and legal matter data, as well as other invoicing and/or legal service issues. The outside service then provides the business with summary reports that identify unauthorized, inaccurate, unnecessary and/or excessive charges as well as underlying inefficiencies, inappropriate billing and the like. These summary reports can include the outside service's recommended solutions and/or suggested techniques for managing the identified issues. The outside service may also directly contact and manage the legal service providers on behalf of the subscribing business.

In another embodiment of the present invention, which is shown for exemplary purposes in FIGS. 1C and 1D, there are three Microsoft Access 2003 databases that form the database system 10 of the present invention. A Microsoft Access 2003 database is provided to a business for entering and storing its legal matter and asset data. This database can be referred to as the “legal matter database” or “legal matter management database” 12. There is also a Microsoft Access 2003 “legal user database” 14 that is provided to a legal service provider for entering invoice data in a form compatible with the database system 10. In one embodiment, both the legal matter 12 and the legal user 14 databases are used to transmit or send data in an electronic format to a Microsoft Access 2003 “analysis database” 16 that relates, tests and analyzes the data.

The three databases 12, 14 and 16 set forth above can be duplicated for each business subscribing to the system 10 such that each business has a completely separate database system 10 from the other subscribing businesses. By providing three separate databases 12, 14 and 16 for each individual business, the business enjoys the advantage that its legal matter database 12 can continue to be used if the analysis database 16 is terminated. As such, the business user can retain and continue to use the legal matter database 12 to organize its legal matters and assets, without using or subscribing to any form of the analysis database 16 to test and analyze invoice data. Moreover, a separate database system 10 belonging to one subscriber is insulated from problems that might occur in another subscriber's database system and can be greatly customized to the desires of that specific subscriber.

In other embodiments of the present invention, different software or other combinations of different software and databases could be used to accomplish the same result in accordance with the present invention. For example a single database provided by Oracle Corporation located at 500 Oracle Parkway, Redwood Shores, Calif. could be used, where the business user and the legal service provider have remote access to the database, allowing both to remotely enter data and perform tasks in the database system. A user could use, and communicate data to, the database system via conventional remote communication mechanisms including but not limited to VPN, web access or internet based communication via connections such as a dial up phone line, DSL, T1 line, or the like.

In another embodiment of the present invention, the legal matter database 12 can be an existing database. For example, legal matter data relating to patents, trademarks and other projects can be provided by conventional intellectual property databases such as Master Data System provided by The Thomson Corporation located at 1 Station PI, Stamford, Conn. and the legal matter management system offered by Computer Packages Inc. located at 414 Hungerford Drive, Rockville, Md. Legal matter data can be extracted from these databases and then be imported into the database system 10 of the present invention.

In yet another embodiment, portions of the analysis database in the database system of the present invention could be integrated into existing legal matter management systems such as the Master Data System provided by The Thomson Corporation located at 1 Station PI, Stamford, Conn. and the legal matter management system offered by Computer Packages Inc. located at 414 Hungerford Drive, Rockville, Md. Likewise, portions of the legal matter database in the database system of the present invention could be integrated into existing legal invoice management systems such as those provided by DataCert Inc. located at 3040 Post Oak Blvd., Houston, Tex. and Lexis Nexis' Examen Inc. located at 3831 N. Freeway Blvd., Sacramento, Calif.

Once the database system is configured and an outside service or business is established to manage the system, data can be entered as follows. In one embodiment, the business provides legal matter data for entry into the database. The business may also request that its legal service providers prepare invoices that can be readily converted and entered into the database system. Preferably users of the system, such as business and legal service provider employees, enter legal matter data and invoice data into the database system, respectively. However, other users including employees of the outside service mentioned above may also enter data into the database system.

Data is conventionally entered into Microsoft Access 2003 database tables with the assistance of Microsoft Access 2003 data entry forms. As shown in the embodiments of FIGS. 1A, 1B, 1C and 1D the method of the present invention starts with the entry 13 of legal matter data into the legal matter database 12. Legal matters are projects requiring legal services and typically include, but are not limited to matters relating to patents, trademarks, contracts, law suits, investigations, patent watches, secrecy agreements, sales and acquisitions, employee issues and other common legal matters including those listed by the Uniform Task Based Management System that can be obtained on their website UTBMS.com, which is hereby incorporated by reference.

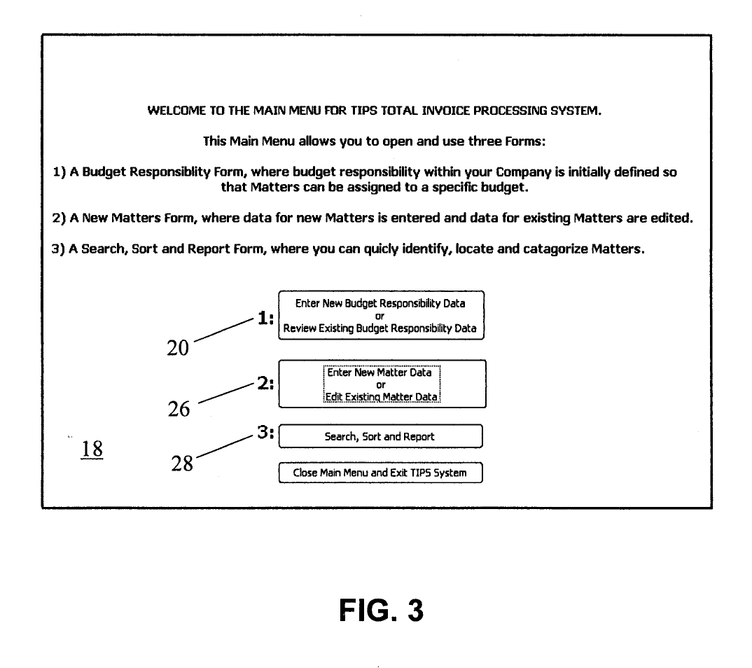

As shown in FIG. 3, a menu 18 is provided in the legal matter database where a user selects options for entering legal matter data. Kindly note that the various menus disclosed herein are exemplary and one of ordinary skill in the art would certainly recognize that countless other menus could be created and used in accordance with the present invention. In any event, the first option 20 is to Enter New Budget Responsibility Data. Selecting this option 20 allows a user to set up and enter business budget data so that legal matters can be associated with a certain internal business budgets for reporting and budget tracking purposes. The business budget data might include Divisions and/or Operating Companies that are responsible for payment of fees and expenses on specific legal matters and assets. This data can be used to calculate inter-company charges by the business' accounting department and can further be used for reporting purposes to show total expenses by a given division or business unit. A user can also select this option 20 to review existing budget data.

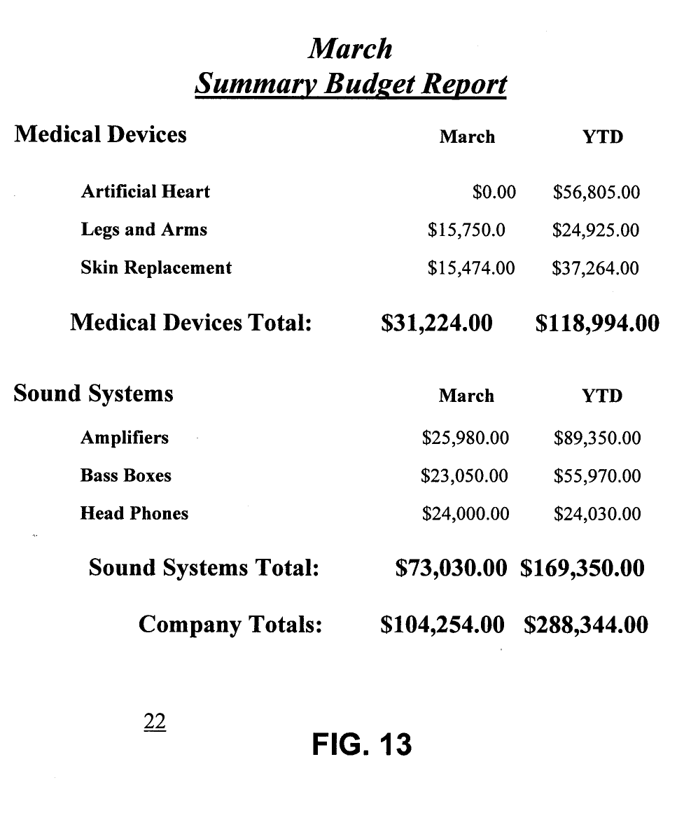

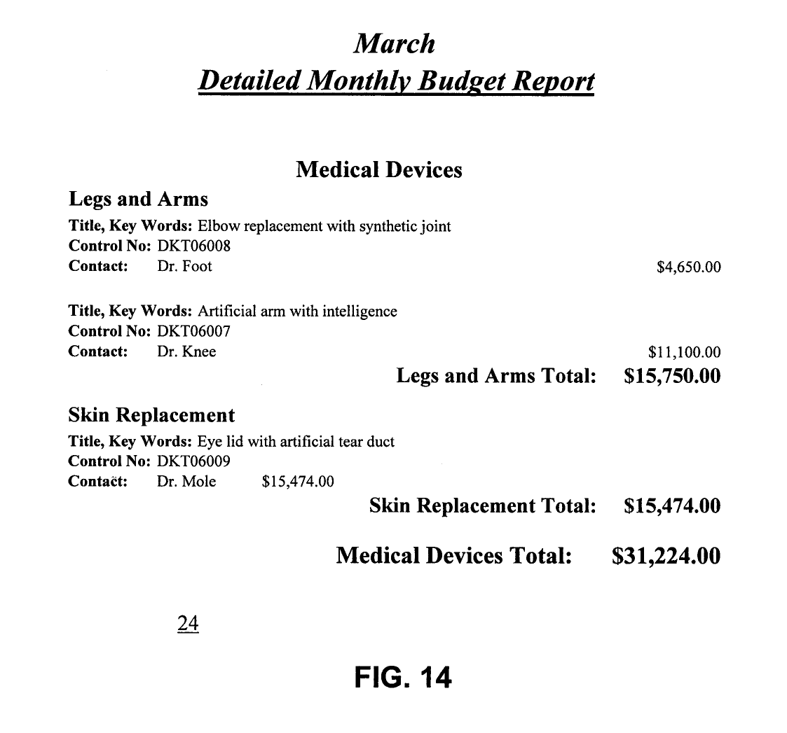

Examples of how a business might typically set up budget responsibility data are as follows. A general counsel legal department within the headquarters of a large company may manage and pay for all legal services required by its Divisions and Operating Companies within those Divisions. However, the general counsel legal department may wish to charge the Divisions and Operating Companies for these legal services. In this case each legal matter should be related to a Division and/or an Operating Company's budget reference. Therefore, budget data would reflect the Divisions as a primary budget reference and the Operating Companies as a secondary budget reference. Expense reports 22 and 24 could then be generated, which are categorized or grouped by budget responsibility as shown in FIGS. 13 and 14.

Another example is when a company has a central budget for legal expenses and wants to track expenses by the type of legal matter for which services are provided. In other words, a company may wish to know how much it spends on each type of legal matter such as patents, trademarks, lawsuits, agreements, etc. and may therefore assign these groups as primary budgets. Secondary budgets would include subcategories to further track spending in greater detail. For example, in a patent primary budget, a business may wish to also track spending in regions, such as North America and Europe. Alternatively, a business may wish to track annuities and taxes separately from patent preparation and prosecution. In this case alternative embodiments of expense reports 22 and 24 would total costs, categorized by these categories and subcategories.

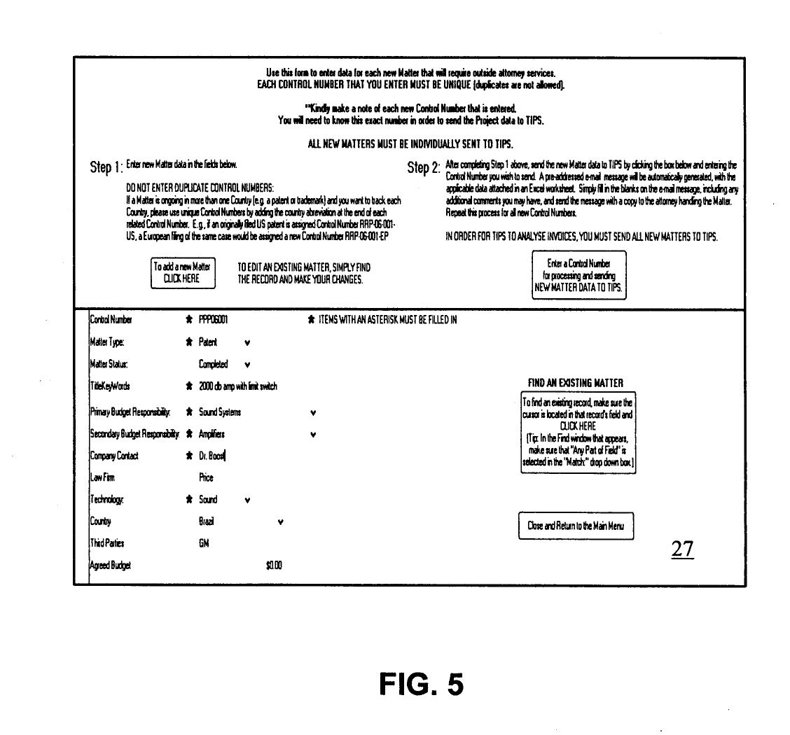

After budget responsibility data is entered, the second option 26 is to Enter New Matter Data. Data that might typically be entered for one legal matter includes, but is not limited to a title, key words, matter reference number or “control number”, business contacts, contact information, law firm, attorney, matter type, matter status, technology, country, business budget information, critical dates, reminder dates, third parties involved in the matter, budget amount for a legal matter, budget amount for a service type, cost target for a service type, patent number, trademark number, serial numbers, number of words in a patent application, asset owner, filing date, inventors, stop all work date, matter completion date, terminated attorneys, team member attorneys working on a legal matter, and the like. Legal matter data can also include accounting data such as budget related information, cost target information, banking information, company information and the business unit or division financially responsible for a legal matter or asset and the like. In an embodiment of the present invention, a data entry form 27 as shown in FIG. 5 is used to enter and send legal matter data within the database system 10.

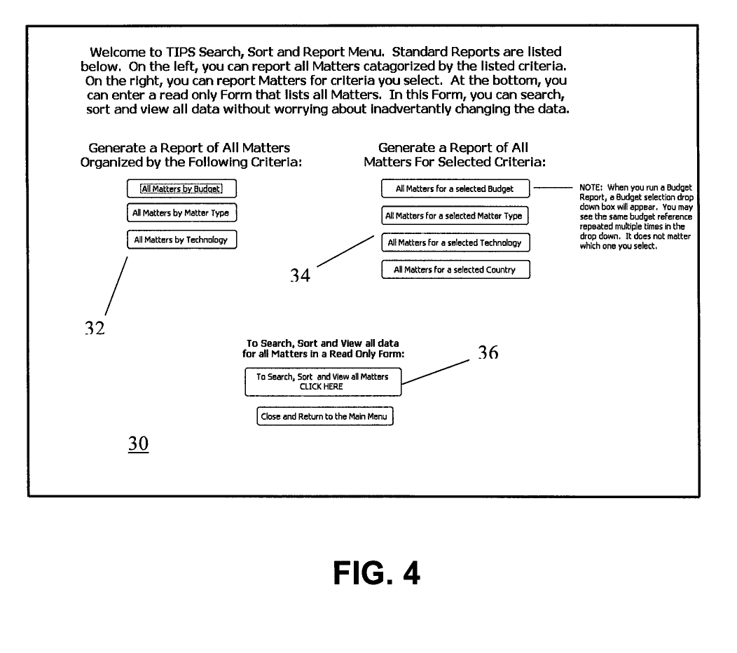

The menu 18 shown in FIG. 3 also includes a third option 28 to Search, Sort and Report legal matter data within the legal matter database 12. If this option is selected, a menu 30 as shown in FIG. 4 can be used to report legal matter data. Standard reports 32 of all legal matters organized by various criteria can be selected and generated, or legal matters for specific criteria can be selected and reported 34. A user of the legal matter database can also Search, Sort and View 36 all legal matters in a conventional Microsoft Access 2003 read only datasheet view. There a user can organize columns of legal matter data in a desired order and then filter and sort the data in those columns to group and view the data as desired. The datasheet view can be read only so that a user does not have to worry about inadvertently modifying the legal matter data. Users can also search for legal matter data in this view by using the conventional Microsoft Access 2003 filter and find functions and entering selected criteria.

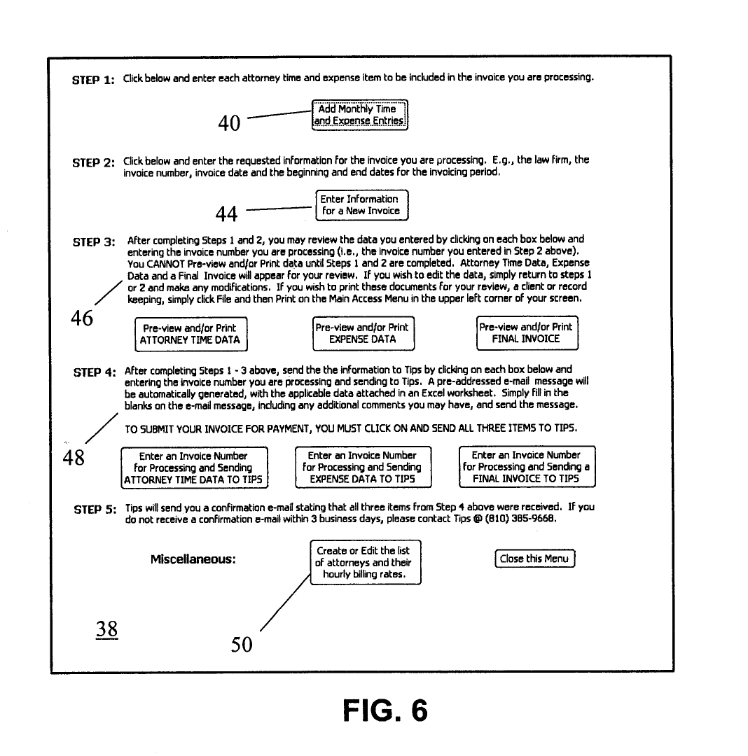

Turning now to invoice data entry, in the legal user database 14 of the present invention a menu 38 as shown in FIG. 6 can be provided. A legal service provider can select options from this menu 38 to enter 13, review and send invoice data. Note, a legal service provider may enter 13 the invoice data or an outside service, as mentioned hereinabove, that manages the database system 10 may also enter invoice data into the database 14.

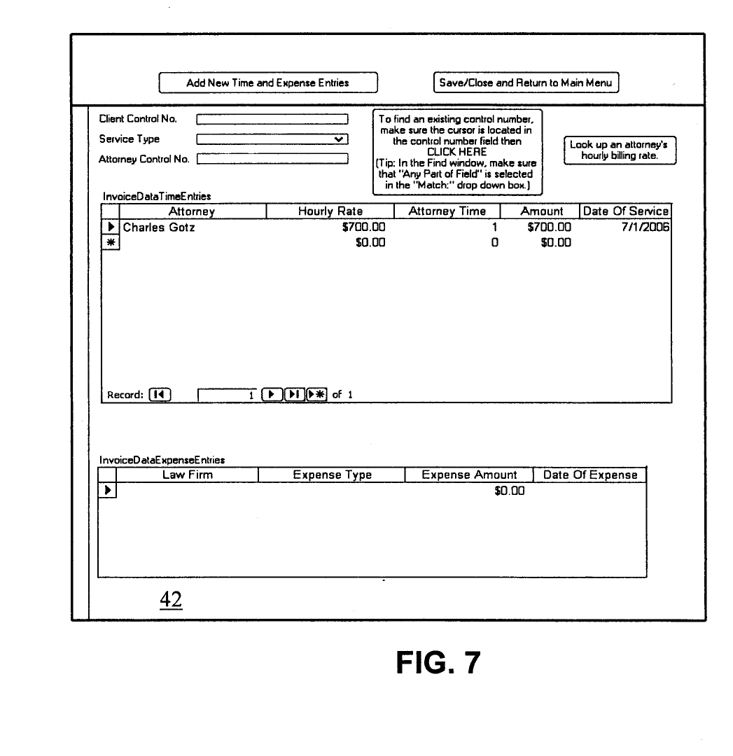

The first option 40 is to Add Monthly Time and Expense Entries. Invoice data entered under this option 40 includes all of the individual charges that might typically be included on a legal invoice, such as a monthly paper invoice. This includes, but is not limited to, client matter reference number, country, attorney matter reference number, service type, law firm, attorney, service date, attorney time, attorney hourly billing rate, attorney amount, expense type, expense date, expense amount and approval date. If the first option 40 is selected from the menu 38 shown in FIG. 6, the data entry form 42 shown in FIG. 7 is used to enter invoice data into the database system 10.

The invoice data entered in this first option 40 includes a service type, which may not typically be included in conventional legal service provider invoices. In accordance with the present invention, each charge in a legal invoice should include a “service type”. By carefully defining service types, the effectiveness of the analysis database 16 of the present invention is greatly enhanced, particularly in the area of intellectual property. As such, before continuing to describe the method of entering data into, and using, the legal user database 14, a detailed description of service types and their relevance is included as follows.

In one embodiment of the present invention, a service type uniquely identifies the service performed by the legal service provider. This invoice data enables the database to calculate the total charge for a specific service performed under a client matter reference number. Total charges for a service type can then be compared to a standard charge for that service type and if the standard is exceeded, a report can be generated and the amount can be adjusted if so desired.

Standard charges can be independently determined by the business and entered into the analysis database 16. Alternatively, the business and the legal service provider may negotiate some or all of the standard charges for service types before they are entered into the analysis database 16. In this instance, a business might typically provide a number of legal service providers with a list of service types and ask them to provide a quote on them, thus indicating a proposed standard charge.

When any in-house business person is asked to review and manage legal matter expenses, they do not typically have the understanding, time or resources to review costs and expenses on a micro scale. For example, they do not want to know how much it costs to prepare an information disclosure statement for the US Patent and Trademark office. Rather, they want to know the total cost to prepare a patent application and the total cost to then get it issued, including both legal fees and expenses. As such, the scope of each service type of the present invention is uniquely defined to minimize the number of service type categories necessary, yet still cover most intellectual property services available. Many of these service types are universal and can be used in all countries. The scope of each service type can include all charges for fees and expenses, which further reduces unnecessary complexity and provides for simple business friendly reports and direct cost comparison between legal service providers.

For example, if a subscribing business has an ongoing lawsuit, that lawsuit would be assigned a unique client matter reference number. A number of services types could be performed during the lawsuit as set forth in the list provided herein below, and each service type might have a number of services that fall within the scope of that particular service type. In a lawsuit, a number of services could be performed including but not limited to pre filing investigation into the merits of the claim, pretrial discovery, conducting depositions, preparing substantive motions and briefs, mediation, trial, the appeal process, and the like. Charges for each of these services would be categorized under the applicable service type as defined in their respective descriptions herein below, such that the database 16 could calculate total charges for and report on each service type.

In another example, if a subscribing business files a patent application, it is assigned a unique client reference number. A number of service types could be performed relating to that patent, and charges under such service types could relate to services such as preparing a novelty search and opinion, drafting a patent application, prosecuting the patent application, foreign filing the patent application, paying maintenance fees for the granted patent, and the like. Each of these services would be categorized under the applicable service type as defined in their respective descriptions herein below, such that the database 16 could calculate total charges for and report on each service type. In both of these examples, all charges are related to a specific legal matter identified by a client matter reference number. As such, the database 16 calculates the total charge for each service type relating to that legal matter.

In particular, the scope of patent application preparation and patent prosecution service types have been uniquely defined to minimize the number of service types, simplify the scope of each service type, allow for a direct cost comparison between attorneys and law firms from all countries, and provide universal service types that can be used in all conventional patent countries.

For example, preparing a patent application can be used as a service type in all countries and charges under this service type can be directly compared from law firm to law firm, attorney to attorney and country to country. Even though the filing fees may vary in each country, the service type for preparing a patent application does not include filing fees, thereby permitting a direct comparison, regardless of the country where the patent is filed or the type of patent application being filed. Typical services for preparing a patent application are listed herein below.

After a patent application is prepared, the next applicable service type is filing and prosecuting a patent application or filing and processing a patent application, depending on the nature of the proceedings for that filing. For example, when a PCT case is filed, the application is not prosecuted to grant. As such, the service type used would be filing and processing a PCT patent application. The same logic is applicable to filing and processing a provisional patent application, which is also not usually prosecuted to grant. Alternatively, when a patent application is filed and prosecuted as a utility patent application, it is prosecuted to grant. As such, this service type would be file and prosecute a utility application, which is universal and can be used in all convention countries. The same logic applies to the service type filing and prosecuting a continuation or divisional application; these applications are also prosecuted to grant in most convention countries.

In any event, these service types can be generically referred to as patent application processing service types, which are defined to include all services relating to filing and processing a type of patent application through a final disposition of the patent application. Final disposition of the patent application can be defined as a patent application where all services relating to a patent application processing service type are completed. Some examples of patent applications at a final disposition can be described as an issued United States patent including any post issuance corrections, a lapsed United States provisional application, a granted utility patent outside the United States where any opposition proceedings have been completed, a completed European patent application immediately prior to going national into various contracting European Patent Office countries, a PCT patent application immediately prior to going national into various contracting PCT countries, a national application that originated from the European Patent Office where all translations and proceedings before the national patent office are completed, and the like. A patent application may reach final disposition prior to the payment of any maintenance fees, taxes or annuities and therefore services relating to such payments are not typically included in patent processing and patent prosecution service types.

Quotes, and ultimately all charges, for filing and processing or prosecuting patent applications will vary from country to country and for different types of patent application filings. However, the database system 10 of the present invention can calculate and directly compare law firm and attorney average charges for such services in the applicable country and/or for the applicable filing type. Moreover, the database 16 of the present invention can compare such service type charges against targets established within various countries as well as for various types of patent applications filings.

Intellectual property service types used in the present invention include, but are not limited to, those listed below. Note that numbers are added to the beginning of each service type to categorize them, as well as to reduce key strokes and speed up data entry when entering data through the use of conventional drop down lists. Sample numbered service types are as follows.

001Novelty search and opinion: All fees and expenses relating to conducting a novelty search and providing an opinion on the scope of patent protection that may be available, including: expenses such as patent searches, on line research, postage, copying, telecommunications, travel, and the like; all services such as reviewing the search parameters identified by the client, searching for references, analyzing references, preparing a written opinion, and the like; and all communications with the client.

101Patent application level 1: All fees and expenses relating to preparing a level one patent application, e.g. a CIP application with relatively little new matter or a very simple patent application, including: all expenses such as formal drawings, postage, copying, telecommunications, travel, and the like; all services such as meeting with inventors, reviewing an invention disclosure, completing the patent application, and the like; and all communications with the client. This does not typically include official fees or expenses for filing.

102Patent application level 2: All fees and expenses relating to preparing a level two patent application, e.g. a basic expense patent application, including: all expenses such as formal drawings, postage, copying, telecommunications, travel, and the like; all services such as meeting with inventors, reviewing an invention disclosure, completing the patent application, and the like; and all communications with the client. This does not typically include official fees or expenses for filing.

103Patent application level 3: All fees and expenses relating to preparing a level three patent application, e.g. an intermediate expense patent application, including: all expenses formal drawings, postage, copying, telecommunications, travel, and the like; all services such as meeting with inventors, reviewing an invention disclosure, completing the patent application, and the like; and all communications with the client. This does not typically include official fees or expenses for filing.

104Patent application level 4: All fees and expenses relating to preparing a level four patent application, e.g. a complex high expense patent application, including: all expenses such as formal drawings, postage, copying, telecommunications, travel, and the like; all services such as meeting with inventors, reviewing an invention disclosure, completing the patent application, and the like; and all communications with the client. This does not typically include official fees or expenses for filing.

105Design application preparation: All fees and expenses relating to preparing a design patent application, including: all expenses such as official patent office fees formal drawings, postage, copying, telecommunications, travel, and the like; all services such as meeting with inventors, reviewing an invention disclosure, completing the application, and the like; and all communications with the client. This does not typically include official fees or expenses for filing.

201File provisional application: All fees and expenses relating to filing a provisional patent application and all communications with the client. This only includes the charges for filing a provisional application and does not include any patent application preparation or review.

202File and prosecute a utility application: All fees and expenses relating to filing and prosecuting a utility patent application and delivering a completed, original granted patent and assignment to the client, including: expenses such as official patent office fees, postage, copying, telecommunications, travel, and the like; patent prosecution services such as preparing and filing formal documents, responses to patent office communications, corrections to the issued patent, and the like; conducting examiner interviews and all other communications with the patent office; and all communications with the client. This does not typically include any patent application preparation or review.

203File and process PCT without prelim exam: All fees and expenses relating to filing and processing a PCT patent application with a search, but without preliminary examination, including: expenses such as PCT official fees, postage, telecommunications, copying and the like; and PCT services such as filing the application, preparation of all documents required in the PCT process, attending to all details of the PCT process, and the like; and all communications with the client. This does not typically include any patent application preparation or review.

204File and process PCT with prelim exam: All fees and expenses relating to filing and processing a PCT patent application with a search and preliminary examination, including: expenses such as PCT official fees, postage, telecommunications, copying and the like; and PCT services such as filing the application, preparation of all documents required in the PCT process, attending to all details of the PCT process and the like; and all communications with the client. This does not typically include any patent application preparation or review.

205File and process national case from EPO: All Fees and expenses relating to filing and processing a national case that originated from a granted EPO case and delivering a completed, original granted patent to the client, including: expenses such as official patent office fees, translations, foreign associate charges, postage, copying, telecommunications, and the like; processing services such as preparing and filing formal documents, responses to patent office communications, corrections to the issued patent, and the like; all other communications with the patent office; and all communications with the client.

206File and prosecute continuation divisional: All fees and expenses relating to filing and prosecuting a continuing or divisional patent application and delivering a completed, original granted patent to the client, including: expenses such as official patent office fees, postage, copying, telecommunications, travel, and the like; patent prosecution services such as responses to patent office communications, corrections to the issued patent, and the like; conducting examiner interviews and all other communications with the patent office; and all communications with the client. This does not typically include any patent application preparation or review.

207File and process a utility model: All fees and expenses relating to filing and prosecuting a utility model and delivering a completed, original utility model and assignment to the client, including: expenses such as official patent office fees, postage, copying, telecommunications, travel, and the like; patent prosecution services such as preparing and filing formal documents and all other communications with the patent office; and all communications with the client. This does not typically include any patent application preparation or review.

208Appeal without oral argument: All fees and expenses relating to preparing and filing an appeal, including: expenses such as patent office fees, postage, copying, telecommunications, travel, and the like; appeal services such as preparing and filing a brief, attending to all details of the appeal process, communicating with the patent office, and the like; and all communications with the client.

209Appeal with oral argument: All fees and expenses relating to preparing and filing an appeal with oral argument, including: expenses such as patent office fees, postage, copying, telecommunications, exhibits, travel, and the like; appeal services such as preparing and filing a brief, attending to all details of the appeal process, communicating with the patent office, attending the hearing, and the like; and all communications with the client.

210Design application prosecution: All fees and expenses relating to filing and prosecuting a design patent application and delivering a completed, original granted patent and assignment to the client, including: expenses such as patent office fees, postage, copying, telecommunications, travel, and the like; patent prosecution services such as preparing and filing formal documents, information disclosure statements, responses to patent office communications, corrections to the issued patent, and the like; conducting examiner interviews and all other communications with the patent office; and all communications with the client.

301Re-exam with participation: All fees and expenses relating to filing and participating in a re-exam, including: expenses such as patent office fees, postage, copying, telecommunications, travel, and the like; services such as preparing the request, attending to all details of the re-exam process, communicating with the patent office; and all communications with the client.

302Re-exam without participation: All fees and expenses relating to filing a re-exam without participation, including: expenses such as patent office fees, postage, copying, telecommunications, travel, and the like; services such as preparing the request, attending to all details of the re-exam process, communicating with the patent office; and all communications with the client.

303Reissue: All fees and expenses relating to filing and prosecuting a reissue patent application and delivering a completed, original granted patent to the client, including: expenses such as patent office fees, postage, copying, telecommunications, travel, and the like; patent prosecution services such as information disclosure statements, preliminary amendments, responses to patent office communications, corrections to the re-issued patent, and the like; conducting examiner interviews and all other communications with the patent office; and all communications with the client.

304Patent opposition: All fees and expenses relating to initiating and maintaining or defending a patent opposition, including: expenses such as patent office fees, exhibits, postage, copying, telecommunications, travel, and the like; services such as preparing and filing briefs, attending to all details of the opposition process, communicating with the tribunal, and the like; and all communications with the client.

305Patent Interference: All fees and expenses relating to initiating and maintaining or defending a patent interference, including: expenses such as patent office fees, exhibits, postage, copying, telecommunications, travel, and the like; services such as preparing and filing briefs, attending to all details of the interference process, communicating with the tribunal, and the like; and all communications with the client.

401Patent status investigation: All fees and expenses relating to determining the status of a publicly available patent or patent application and all communications with the client.

402Patent (non)infringement investigation: All fees and expenses relating to determining if the subject embodiments infringe or do not infringe the subject patents, including: expenses such as postage, copying, telecommunications, travel, and the like; all services such as analyzing the subject embodiments, analyzing the subject patents and patent applications, preparing a written opinion, and the like; and all communications with the client.

403State of the art search and opinion: All fees and expenses relating to conducting a state of the art search and providing an opinion summarizing the state of the art, including: expenses such as patent searches, on line research, postage, copying, telecommunications, travel, and the like; all services such as reviewing the search parameters identified by the client, searching for references, analyzing references, preparing a written opinion, and the like; and all communications with the client.

404Patent (in)validity search and opinion: All fees and expenses relating to conducting a validity search and providing an opinion summarizing the validity or invalidity of the subject patent, including: expenses such as foreign and domestic patent searches, on line research, postage, copying, telecommunications, travel, and the like; all services such as reviewing the subject patent, searching for references, analyzing references, preparing a written opinion, and the like; and all communications with the client.

405Freedom to practice search and opinion: All fees and expenses relating to conducting a search and providing an opinion on the freedom to practice embodiments without infringing third party patents, including: expenses such as patent searches, on line research, postage, copying, telecommunications, travel, and the like; all services such as analyzing the subject embodiment, searching for patents and patent applications, analyzing patents and patent applications, preparing a written opinion, and the like; and all communications with the client.

406Patent watch: All fees and expenses relating to conducting and maintaining a patent watch, including: expenses such as online charges, postage, copying, telecommunications, and the like; services such as reviewing the subject patents and publications, reporting to the client, and the like; and all communications with the client.

501Trademark search and opinion: All fees and expenses relating to conducting a trademark search and providing an opinion on the scope of trademark protection that may be available, including: expenses such as trademark searches, on line research, postage, copying, telecommunications, and the like; all services such as searching for references, analyzing references, preparing a written opinion, and the like; and all communications with the client.

502Trademark file and prosecute domestic: All fees and expenses relating to filing, prosecuting and registering a domestic trademark application, including: expenses such as trademark office fees, postage, copying, telecommunications, travel, and the like; trademark prosecution services such as attending to all details of the trademark prosecution process, communicating with the trademark office, responses to trademark office communications, and the like; and all communications with the client.

503Trademark file and prosecute ECU: All fees and expenses relating to filing, prosecuting and registering a ECU trademark application, including: expenses such as trademark office fees, postage, copying, telecommunications, travel, and the like; trademark prosecution services such as attending to all details of the trademark prosecution process, communicating with the trademark office, responses to trademark office communications, and the like; and all communications with the client.

504Trademark renewal: All fees and expenses relating to renewal of an existing registered trademark, including expenses such as trademark office fees, postage, copying, telecommunications, travel, and the like; trademark renewal services such as attending to all details of the trademark renewal process, preparing affidavits, communicating with the trademark office, responses to trademark office communications, and the like; and all communications with the client.

505Trademark opposition: All fees and expenses relating to initiating and maintaining or defending a trademark opposition, including: expenses such as trademark office and/or court fees, exhibits, postage, copying, telecommunications, travel, and the like; services such as preparing and filing briefs, attending to all details of the opposition process, communicating with the tribunal, and the like; and all communications with the client.

506Trademark watch: All fees and expenses relating to conducting and maintaining a trademark watch, including: expenses such as online charges, postage, copying, telecommunications, and the like; services such as reviewing the subject trademarks, reporting to the client, and the like; and all communications with the client.

507Trademark (non)infringement investigation: All fees and expenses relating to conducting a trademark investigation to determine if the trademarks infringe or do not infringe the subject trademark, including: expenses such as trademark searches, on line research, postage, copying, telecommunications, travel and the like; all services such as searching for references, analyzing references, and providing an opinion on the scope of trademark protection, preparing a written opinion, and the like; and all communications with the client.

508Trademark investigation: All fees and expenses relating to an investigation of the subject trademark, including: expenses such as trademark searches, on line research, postage, copying, telecommunications, travel and the like; all services such as searching for references, analyzing references, and providing an opinion on the subject trademark and the like; and all communications with the client.

601Litigation—pre-discovery: All fees and expenses relating to the pre-discovery phase of an intellectual property dispute including: all expenses such as transcripts, court fees, postage, copying, telecommunications, travel, and the like; all litigation services such as reviewing the disputed matters, attending to pre-discovery court proceedings and requirements, and the like; and all communications with the client.

602Litigation—discovery: All fees and expenses relating to the discovery phase of an intellectual property dispute including: all expenses such as investigator expenses, transcripts, court fees, postage, copying, telecommunications, travel, and the like; all services such as taking depositions, preparing and answering interrogatories and requests for admissions, attending to court proceedings and requirements, and the like; and all communications with the client.

603Litigation—markman: All fees and expenses relating to a Markman proceeding in an intellectual property dispute including: all expenses such as trial exhibits, experts, transcripts, court fees, postage, copying, telecommunications, travel, and the like; all litigation services such as preparing a Markman brief, attending to the Markman hearing, and the like; and all communications with the client.

604Litigation—experts: All fees and expenses relating to experts in an intellectual property dispute including: all expenses such as outside expert expenses, expert reports, exhibits, transcripts, court fees, postage, copying, telecommunications, travel, and the like; all litigation services such reviewing expert reports, consulting with experts, and the like (not including expert discovery); and all communications with the client.

605Litigation—dispositive motions: All fees and expenses relating to dispositive motions in an intellectual property dispute including: all expenses such as local counsel expenses, court fees, postage, copying, online research fees, telecommunications, travel, and the like; all litigation services such as preparation of motions and briefs, attending to any court proceedings and requirements, and the like; and all communications with the client.

606Litigation—trial: All fees and expenses relating to trial for an intellectual property dispute including: all expenses such as trial exhibits, experts, local counsel expenses, investigator expenses, transcripts, court fees, online research fees, postage, copying, telecommunications, travel, and the like; all litigation services such as preparing for trial, preparing briefs, attending to any court proceedings and requirements, and the like; and all communications with the client.

607Litigation—appeal: All fees and expenses relating to an appeal of the trial court decision in an intellectual property dispute including: all expenses such as transcripts, court fees, online research fees, postage, copying, telecommunications, travel, and the like; all litigation services such as preparing appeal briefs, attending to any court proceedings and requirements, and the like; and all communications with the client.

608Litigation—general catch all: All fees and expenses relating to an intellectual property dispute, which cannot be categorized as one of the above service types (601-607).

701Contract preparation and negotiation: All fees and expenses relating to preparing and negotiating a contract, including all expenses such as postage, copying, telecommunications, and the like; all services such as drafting the agreement, reviewing the applicable law, attending to negotiation of the contract, counseling the applicable business people, and the like; and all communications with the client.

702Contract analysis: All fees and expenses relating to analyzing and interpreting a contract, including all expenses such as postage, copying, telecommunications, and the like; all services such as reviewing the subject contract, reviewing applicable law, and the like; and all communications with the client.

703IP due diligence—acquisition or divestiture: All fees and expenses relating to conducting a due diligence investigation and preparing a due diligence report, including: all expenses such as on line computer searches, postage, copying, telecommunications, travel, and the like; all services such as reviewing the subject intellectual property portfolio, reviewing intellectual property agreements, reviewing potential and ongoing intellectual property disputes and litigation issues, preparing a due diligence report, and the like; and all communications with the client.

800Payment of patent annuities: All fees and expenses relating to payment of patent taxes, maintenance fees, annuities and the like.

999Miscellaneous: Any fees and expenses that do not relate to any of the service types listed above.

In accordance with the present invention, additional service types could also be utilized and existing service types could be renamed or modified to better meet the requirements of a particular business. For example, rather than having patent application preparation service types listed under various numeric levels of difficulty, other businesses might desire that patent application preparation be categorized by the type of technology involved. Examples might include but are not limited to categorizing patent application preparation service types by mechanical applications, electrical applications, chemical applications, biotechnology applications, and the like. Moreover, general legal service types could also be used in conjunction with intellectual property service types.

As mentioned above, in the method and system of the present invention, expense charges can be included in the cost targets or cost standards established for each service type. These expenses are categorized for tracking purposes by expense types. In one embodiment of the present invention, intellectual property expense types used in the system 10 include but are not limited to the following: 001Patent office fees except extensions; 002Patent office extensions of time; 003Annuities; 004Trademark office fees; 101Drawings; 102Patent copies; 103File wrapper copy; 104Outside patent search; 105Translation; 201Foreign associate charges; 202Fixed service fee; 301Copying and printing; 302Postage Delivery Courier; 303Telecommunications; 401Travel; 402Lodging; 403Meals; 501Online research; 502Any Court fee; 503Arbitrator Mediator; 504Experts; 505Litigation support; 506Local counsel; 507Other professionals; 508Private investigators; 509Transcripts; 510Trial exhibits; 601Discount; 701Bank fees and 999Miscellaneous.

In another embodiment of the present invention, the service types used in the database system 10 include service types set forth by the Uniform Task Based Management System as defined on their website UTBMS.com. Likewise expense types used in the database system of the present invention include, but are not limited to, those set forth by the Uniform Task Based Management System as defined on their website UTBMS.com. One of ordinary skill in the art would recognize that any number of other service and expense types could be described and used.

With service types now described in detail, further description of the method for entering 13 invoice data and using the legal user database 14 is continued as follows. In the menu 38 shown in FIG. 6, option two 44 is to Enter Information for a New Invoice. Data entered under this option 44 is general invoice information that is typically included one time in a traditional paper legal service invoice. This includes, but is not limited to, legal service provider name, client name, invoice number, invoice date, invoice period start date and invoice period end date, as well as an exchange rate if the invoice is in a foreign currency.

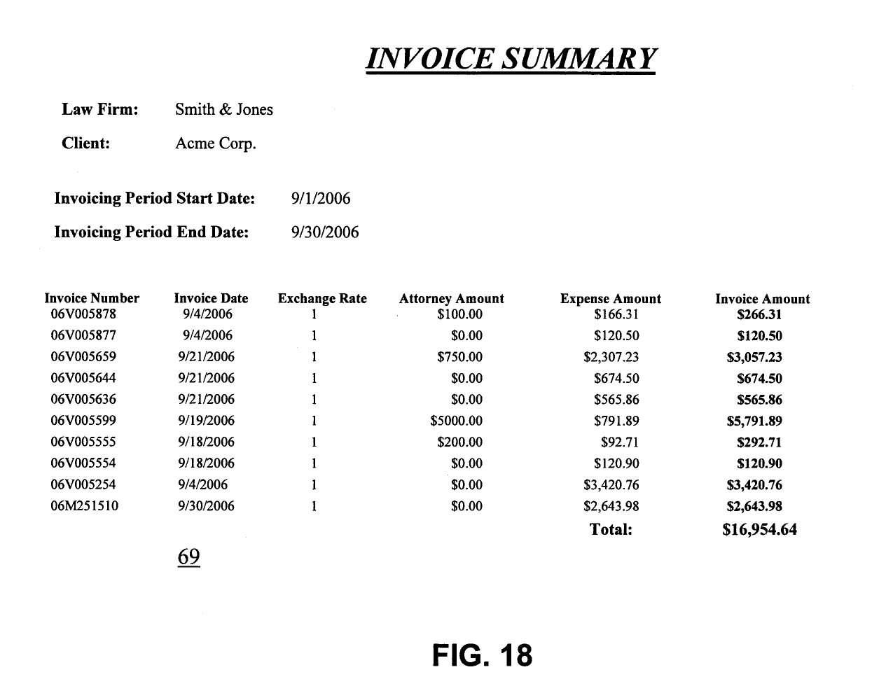

As such, a legal service provider using this legal user database 14 to create a monthly invoice would first enter all the individual charges for a given month under option one 40 and then enter the general invoice information under option two 44. By selecting option three 46, the user can view and print all individual attorney time and expense data that was entered under option one 40. Under option three 46, a user can also view and print an actual detailed invoice. This actual invoice includes a summary sheet 69 as shown in FIG. 18, which lists the invoice number, invoice date, client name, legal service provider name, attorney time and expense totals, invoice total and the like. Finally, under option four 48 in the menu 38 shown in FIG. 6, invoice data is transmitted for entry into the analysis database 16 and processing by the business or outside service. In one embodiment, invoice data can be transmitted by e-mail.

Also included in the menu 38 shown in FIG. 6 is option five 50. When selected, option five 50 provides a data entry form for entering individual legal service providers and their hourly billing rates. After the legal service provider data is entered, legal service providers can be selected from drop down lists in the data entry forms.

In an alternative embodiment of the present invention, a legal user database is used for “matter based” invoices. As is common outside the United States, a separate legal invoice may be provided each time a different legal matter is serviced. Hence, multiple invoices from a single legal service provider may be received in one month. In this embodiment, the first and second options 40 and 44 are combined. In other words, time and expense entry data and new invoice data from each matter based invoice is collectively entered into the database 14, including any applicable exchange rates. As such, if a business processes all of its invoices on a monthly basis, multiple matter based invoices from one legal service provider are processed as a group each month.

When multiple invoices from one provider are processed in a given month, this group of invoices is assigned a batch number. This batch number is used in place of an invoice number to view and print all individual invoices under option three 46. A user can also view and print all of the actual detailed invoices. This actual invoice includes a summary sheet 69 first as shown in FIG. 18, which itemizes each invoice number, invoice date, attorney time and expense totals, invoice total for a given client and legal service provider. Finally, under option four 48, the batch of invoice data is transmitted for entry into the analysis database 16 and processing by the business or outside service. By processing multiple invoices as a batch, individual invoices do not require separate processing, which saves considerable processing time.

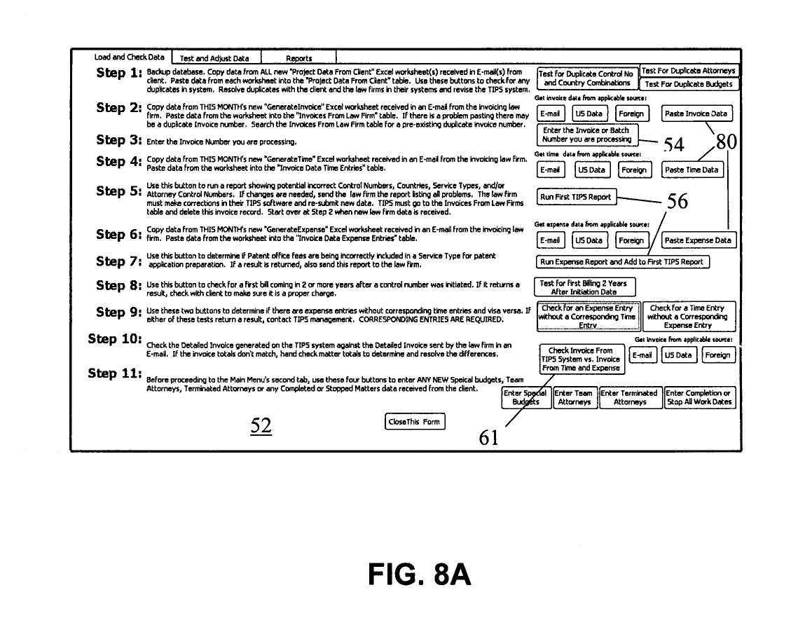

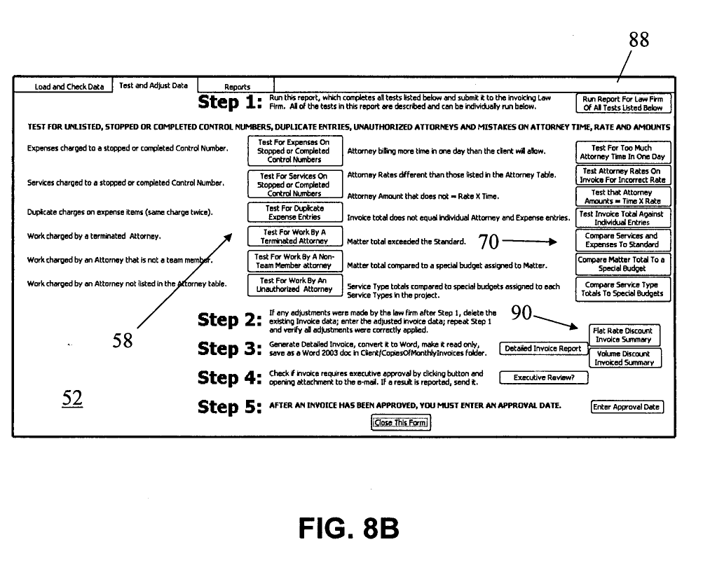

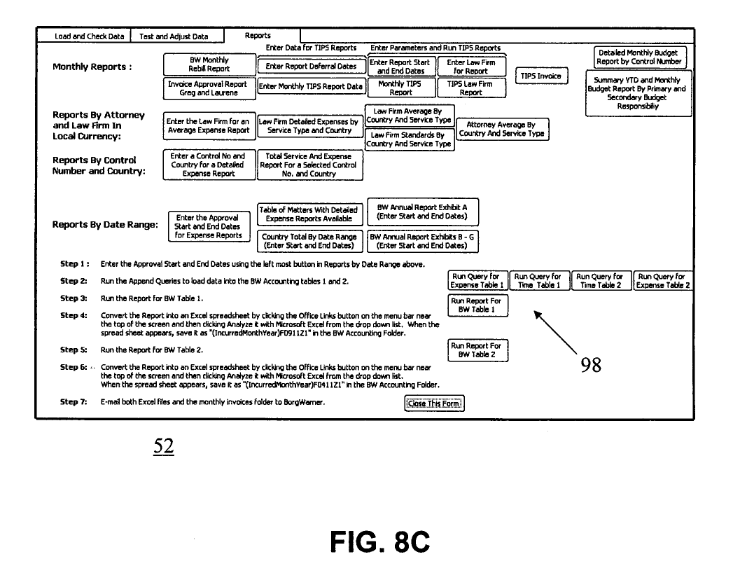

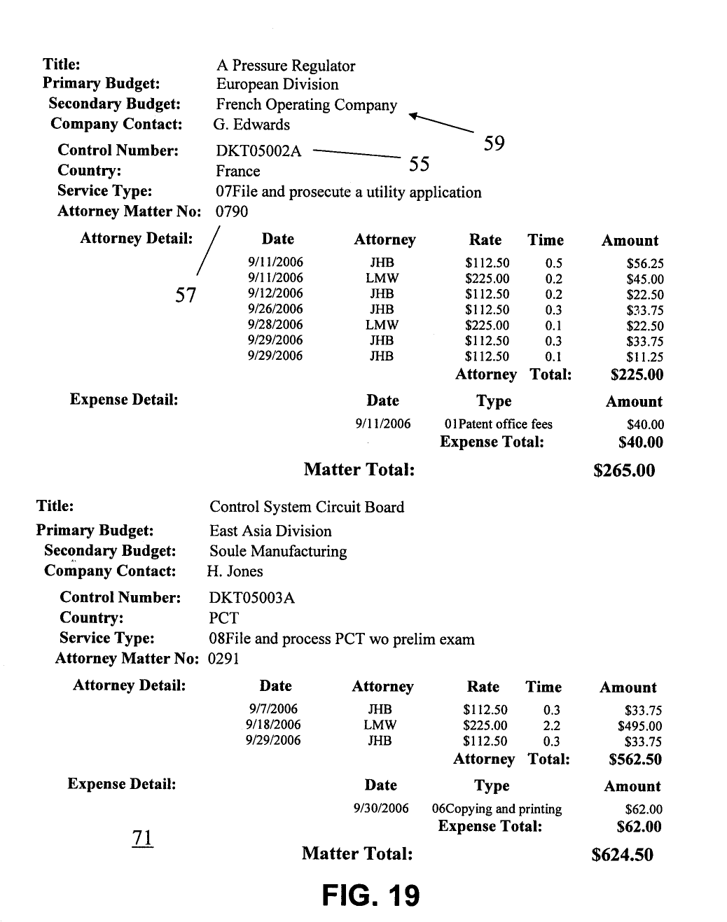

As shown in FIG. 8A, after monthly and/or matter based invoice data is exported from database 14 and imported into database 16, an invoice can be generated 61 from database 16 as shown in FIG. 19. This invoice from database 16 should be identical to the same invoice generated in database 14. As such invoices from both systems can be compared to double check that all invoice data, including any adjustments thereto, from database 14 were correctly entered into database 16. In another embodiment of the present invention where databases 12, 14 and 16 are combined in one database, this check would not be necessary since legal matter and invoice data would both be entered directly into the same database. It should also be noted that other conventional diagnostic tests can be completed on both legal matter and invoice data to make sure it has been properly entered into the database. For example tests for duplicate entries and the like.

Now that legal matter and invoice data are entered into the system 10 of the present invention and checked, the analysis database 16 relates, tests and analyses invoice and legal matter data, as shown in the embodiments of FIGS. 1A, 1B, 1C and 1D. In one embodiment, legal matter data and invoice data generally come from different sources; legal matter data comes from a business and invoice data comes from a legal service provider. In order for the database system 10 to relate invoice data to legal matter data, a unique field that is common to both types of data is required. With regard to legal matters, unique fields specifically identify each legal matter entered in the database. With regard to legal invoices, unique fields specifically identify the legal matter that each charge on the invoice applies to.

In one embodiment of the present invention, data relating to legal matters and assets is entered into the database system 10 under matter identifying codes. One such code is commonly referred to as a “matter reference number”. Matter references numbers alone, or in combination with other identifiers, uniquely identify all data relating to each legal matter or asset in the database system 10. A legal service provider's fees, expenses and other invoice data are also entered into the database system under these matter identifying codes. Each charge on an invoice should include the client matter reference number so that it can be related and applied to a unique legal matter.

Other data can also be used in combination with the matter reference number to uniquely identify legal matters, including but not limited to a country and/or matter type that relates to a given matter reference number. For example, in intellectual property legal matters such as patents and trademarks, different types of applications for identical subject matter are filed separately in various countries. In this case, the same matter reference number may be used in a number of different countries and for a number of different patent application types. However, other unique identifiers, or combinations thereof, can be used to distinguish the various matters.

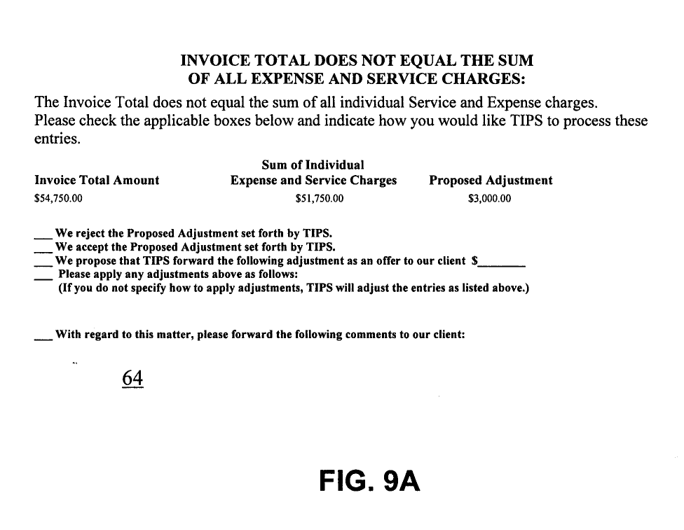

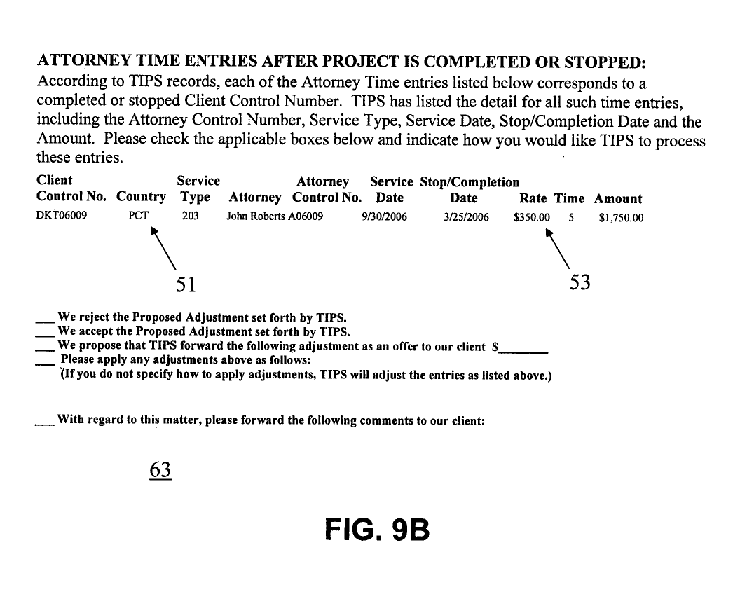

By linking legal matter data to invoice data, the database system becomes a powerful tool that can be used for accounting, legal and business management purposes. Fields for legal matters and assets within the legal matter management database can be populated with selected invoice data. Tests can be performed by the analysis database 16 on the invoice data, and test results can be provided with both invoice data and the related legal matter. For example, in one embodiment of the present invention, the invoice data is tested to determine if any charges occurred after a legal matter has been stopped or completed. In other words, if a service date entered for a charge was after a completion date entered for a legal matter, the test would return a result. If the test results showed that a charge did occur after the legal matter was completed, the database can generate a report as shown in FIG. 9B. Since the legal matter and invoice data are related, the report can identify both the applicable legal matter data 51 as well as the invoice data 53 relating to that matter, which occurred after completion.

In addition, expense reports can be generated for various legal matters and assets, and can include and be sorted by any fields in the database. For example, expense reports can include and be sorted by fields including but not limited to law firm, division, business unit, legal matter type, technology, service type, attorney, matter reference number, expense type, key words, region, comments, analysis and/or date ranges. These reports enable the legal matters to be better monitored and managed by an in house legal team or by business managers.

As shown in FIG. 19, another benefit is that all legal service provider invoices can be reformatted to be viewed, searched, printed and stored in a common electronic format. In accordance with the present invention, the analysis database 16 can support this common format for both monthly invoices and matter based invoices, from both domestic and foreign legal service providers. This common format can be dictated by the business. For example, a business may wish to have matters on the invoice sorted by the business' matter reference number 55 rather than by the attorney's matter reference number 57.

Since legal matter and invoice data are linked in the analysis database 16, the business may also wish to include selected business information 59 on the invoices. For example, legal matters on invoices can be identified by key words that are chosen, and easily recognized, by the business rather than a non-descriptive title prepared by the outside attorney. A sample invoice 71 is shown in FIG. 19. In addition, commonly formatted summary sheets 69 can be included at the beginning of each invoice or group of invoices as shown in FIG. 18. With all legal service provider invoices summarized and in a common electronic format, invoice review is substantially quicker and easier. This is particularly true with foreign matter based invoices where multiple invoices are received and processed for payment in one month.

In one embodiment of the present invention, the analysis database 16 provides a menu 52 with several options as shown in FIGS. 8A, 8B and 8C. Under option 54, a user enters the invoice or batch number being tested and/or analyzed. Under option 56, a first series of tests identify if invoice data has been incorrectly stated by a legal service provider. For example, the system detects if charges relating to certain legal matters have incorrect matter reference numbers, countries, service types or expense types. These issues are reported, reviewed and corrected by users of the system.

One test can be conducted to help identify if a client matter reference number has been incorrectly entered. In one embodiment, this test compares selected combinations of new invoice data against invoice data already existing in the database system 10. For example, in an embodiment of the present invention as set forth above, all invoice charges are entered into the database 16 under a combination of identifying codes such as client matter reference number, country, service type, and attorney matter reference number. In one embodiment, the database system 10 checks the combination of a client matter reference number, a service type and an attorney matter reference number to determine if this exact combination has already been entered in the database system 10. If not, the new client matter reference number is reviewed to determine if it is a newly authorized matter number by the business. If not, the analysis database user will contact the legal service provider and question if an incorrect client matter reference number has been entered.

Note, if the exact combination already exists in the database system 10, but is incorrectly applied to a new invoice charge, this test will not catch the error. However, the new charge will be erroneously applied to an already existing legal matter. This could cause the existing legal matter to exceed its cost standard or budget, thereby indicating that an error may have taken place.

In another embodiment, this test can be conducted on invoice data where all charges are entered into the database 10 under a combination of identifying codes which include client matter reference number, country and service type. In other words, new invoice data could be checked to determine if the exact same combination of client matter reference number, country and service type has already been entered in the database system 16. In this instance the test is exactly the same as above, except the country field is substituted for the attorney matter reference number field. If the exact combination does not already exist in the database 16, the new client matter reference number is reviewed to determine if it is a newly authorized matter number by the business. If not, the analysis database user will contact the legal service provider and question if an incorrect client matter reference number has been entered as set forth above.

A number of additional preliminary tests 56 can be conducted to determine if an incorrect client matter reference number, country or service type has been used. In one embodiment of the present invention, client matter reference numbers are in a format that indicates the matter type they identify. In an intellectual property application, examples include but are not limited to client reference numbers that begin with a “P” for patent matters, begin with a “T” for trademark matters, begin with an “L” for litigation matters, begin with a “C” for contract matters, begin with an “I” for investigation matters, and the like. By identifying the matter type in the client matter reference number, tests can be conducted to determine if the charges have been invoiced under the correct service type.

As such, if the database 10 of the present invention detects charges under a client matter reference number beginning with a “P” for a patent matter, but the service type is unrelated to patents, e.g. trademark search and opinion, the charge fails the test and is flagged for review. Likewise, if charges for a patent service type e.g., file and prosecute a utility patent application, are invoiced under a client matter reference number beginning with a “T” for a trademark matter, the charge fails the test and is flagged for review. This test is also conducted to determine if charges under client matter reference numbers for trademarks, investigations, contracts, litigations and the like are invoiced under service types unrelated to those matters.

Similar preliminary tests 56 are also conducted to determine if charges listed under a certain service type and country do not match. Examples of these tests include but are not limited to a test for a PCT service type being used in a country other than the PCT. Kindly note that in the database 10 of the present invention, PCT or Patent Convention Treaty and EPC or European Patent Convention are listed as country codes for patents filed in their respective patent offices. Under this test, if charges are invoiced under a PCT service type, e.g. file and process a PCT application with preliminary exam, and the country is not PCT, the test fails and the charges are flagged for review. Likewise, if charges are listed under a non-PCT service type, e.g. novelty search and opinion, and the country is listed as PCT, the test fails and the charges are flagged for review. Similar tests are conducted to determine if an EPO service type, e.g. file and process a national case from the EPO, is being used in a non-EPO contracting country such as China. Another test checks for a law firm that resides in one country, but is charging for preparing a patent application for filing in another country. While this is possible, it is uncommon and is therefore flagged for review.

In another embodiment of the present invention, client matter reference numbers can be formatted to indicate if a patent matter is i) the original, first filed, parent patent application, ii) a subsequent foreign filed application claiming priority from the original case, iii) a continuation or divisional of an earlier filed case, and/or iv) relating to a technology or business unit. Examples include but are not limited to i) using a standard format for a client matter reference number for an original patent, ii) adding one type of suffix to a matter reference number to indicate that it is a continuation, iii) adding a different suffix to a matter reference number to indicate that it is a continuation in part, iv) adding another type of suffix to a matter reference number to indicate that it is a divisional, v) adding yet another type of suffix to indicate that it is a subsequent foreign filed application that claims priority from an original case, vi) adding another unique suffix to indicate that it is a subsequent filing of a different type of application that claims priority from an original case and/or vii) adding another unique suffix to indicate the technology or business unit that applies to the matter. With this or similar formatting in place, tests can be conducted to determine if charges under various service types are valid. Kindly note that prefixes or other similar combinations of formatting could also be used.

Examples of such tests 56 include but are not limited to the following. A test for charges under an original patent application preparation service type, e.g. preparing a patent application level one, that are invoiced under a patent matter reference number for a continuation or divisional application. Since all original application preparation should be completed before a continuation or divisional is filed, the test fails and the charges are flagged for review. Likewise, a test can be conducted for charges relating to a continuation or divisional service type, e.g. file and prosecution a continuation or divisional, that are incorrectly invoiced under a patent reference number for an original patent application. Again, the test would fail and the charges flagged for review.

Other logic based tests 56 can be conducted to determine if services and expenses are being charged under client matter reference number, country, service type and expense type combinations that simply should not fall under those combinations. Further examples include but are not limited to a test for patent office official fees being charged under a patent application preparation service type. A test for charges under a patent application preparation service type with a level of difficulty that is different than specified by the client. A test for charges under multiple service types, which all relate to the same matter reference number.

After corrections to any client matter reference numbers, countries and service types and the like are made, a user of the analysis database can conduct tests on the invoice data by selecting test options 58 from the menu shown in FIG. 8B. As shown in FIGS. 1C and 1D, the database tests for errors and violations of invoice guidelines 60, and also detects charges that are over a standard or budgeted amount 72. The database system then generates reports 62 identifying the legal matters and invoice charges where such errors, violations and overcharges have occurred.

Data is tested and analyzed by conventional Microsoft Access 2003 queries, which can be constructed by one of ordinary skill in the art to determine when guidelines have been violated, errors have been made and overcharges have occurred. The data identified by the queries is reported in conventional Microsoft Access 2003 reports, which can be constructed by one of ordinary skill in the art to provide the identified data in a desired format and also make some conventional calculations as shown in FIGS. 9A, 9B, 10 and 11.

In this embodiment, businesses provide guidelines that specify unacceptable billing practices. These guidelines are shared with the businesses' legal service providers and entered into the analysis database 16. The database 16 checks invoice data from the legal service providers for violations of these billing guidelines. Tests determine if conditions are met, which would indicate that an error has occurred or that guidelines have been violated. Violations are reported to both the legal service provider and the business enabling them to recognize the violations and adjust the invoice data.

In one embodiment shown in FIGS. 1C and 1D, tests are first conducted to determine if there are invoice errors or violations of guidelines in the invoice data 60. If there is a violation or error, a report is generated that includes selected legal matter and invoice data, which identify the applicable legal matter and the error or violation 62. Exemplary reports 64 and 63 are shown in FIGS. 9A and 9B. The following is a list that includes, but is not limited to the types of tests conducted by conventional queries and techniques in the database of the present invention.

Test for too many attorney hours in one day. If an attorney has billed more hours in one day than the maximum number of hours allowed by a business, guidelines have been violated and selected legal matter and invoice data is reported.

Test for an unauthorized attorney. If an attorney that is not authorized to work for a business has charged that business on an invoice, guidelines have been violated and selected legal matter and invoice data is reported.

Test for expenses under an unauthorized client matter reference number. If an expense on an invoice is charged to a client matter reference number that has not been authorized by the business, guidelines have been violated and selected legal matter and invoice data is reported.

Test for services under an unauthorized client matter reference number. If an attorney charges for a service under a client matter reference number that has not been authorized by the business, guidelines have been violated and selected legal matter and invoice data is reported.

Test for duplicate expense entries. If a duplicate expense is on an invoice, guidelines have been violated and selected legal matter and invoice data is reported. Test for duplicate attorney time entries. If a duplicate attorney time entry is on an invoice, guidelines have been violated and selected legal matter and invoice data is reported.

Test for the invoice total to equal all individual expense and attorney time entries. If the invoice total does not equal all the individual expense and attorney time entries, guidelines have been violated and selected legal matter and invoice data is reported. See FIG. 9A for an exemplary report.

Test for each attorney time entry to equal the attorney rate multiplied by the attorney time. If an attorney time entry does not equal the attorney rate multiplied by the attorney time for that entry, guidelines have been violated and selected legal matter and invoice data is reported.

Test for correct exchange rate on foreign currency. If an invoice is submitted with a foreign currency exchange rate that is significantly different from the exchange rate quoted by an internationally recognized source, guidelines have been violated and selected invoice data is reported.

Test for attorney time entries occurring after a legal matter has been stopped or completed. If an attorney charges for a service after a legal matter has been stopped or completed, guidelines have been violated and selected legal matter and invoice data is reported. See FIG. 9B for an exemplary report.

Test for a first attorney time entry occurring more than a set period after a legal matter has initiated. If an attorney's first charge under a legal matter is more than a set period, for example two years, after the legal matter was initiated, guidelines have been violated and selected legal matter and invoice data is reported.

Test for expense entries occurring after a legal matter has been stopped or completed. If an expense has been charged after a legal matter has been stopped or completed, guidelines have been violated and selected legal matter and invoice data is reported.

Test for inaccurate attorney hourly rates. If an attorney's hourly rate is not the same as the most recent hourly rate provided by that attorney or their law firm, guidelines have been violated and selected legal matter and invoice data is reported.

Test for charges by an attorney that has been terminated. If a business has terminated an attorney, i.e. the business has forbidden that this attorney be allowed to work on any of its legal matters, any further charges by this attorney are a violation of guidelines and selected legal matter and invoice data is reported.

Test for charges by a non-team attorney. The business can specify that only certain attorneys shall be permitted to perform work on a certain project. For example, a business may specify only a team of certain attorneys shall be allowed to work on a litigation project. Any charges by a non-team attorney under that project are a violation of guidelines and selected legal matter and invoice data is reported.

As shown in FIGS. 1C and 1D, any reports 63 and 64 generated 62 as a result of these tests are sent to the legal service provider who provided the invoice data. In one embodiment of the present invention shown in FIG. 9A, the report 64 includes proposed changes or “adjustments” that would correct the invoice data error or place the invoice in compliance with the billing guidelines. The exemplary reports 63 and 64 shown in FIGS. 9A and 9B also include multiple response options for the legal service provider to choose from, indicating how they wish to respond to the report. The legal service provider reviews 66 these reports and determines if adjustments will be made to the invoice data. If adjustments are made, the legal service provider may indicate 68 how any such adjustment should be applied to the invoice data and may provide comments that will ultimately be forwarded to the business and may be entered into the database. Adjusted invoice data can then be entered into the database system 10. Adjustments could certainly also be made by the legal service provider in database 14 and the new adjusted data could reentered into the database 16. As shown in FIGS. 1A and 1B, after adjustments are entered 13, the adjustment process is repeated until there are no new test reports to be sent 19 to the legal service provider.

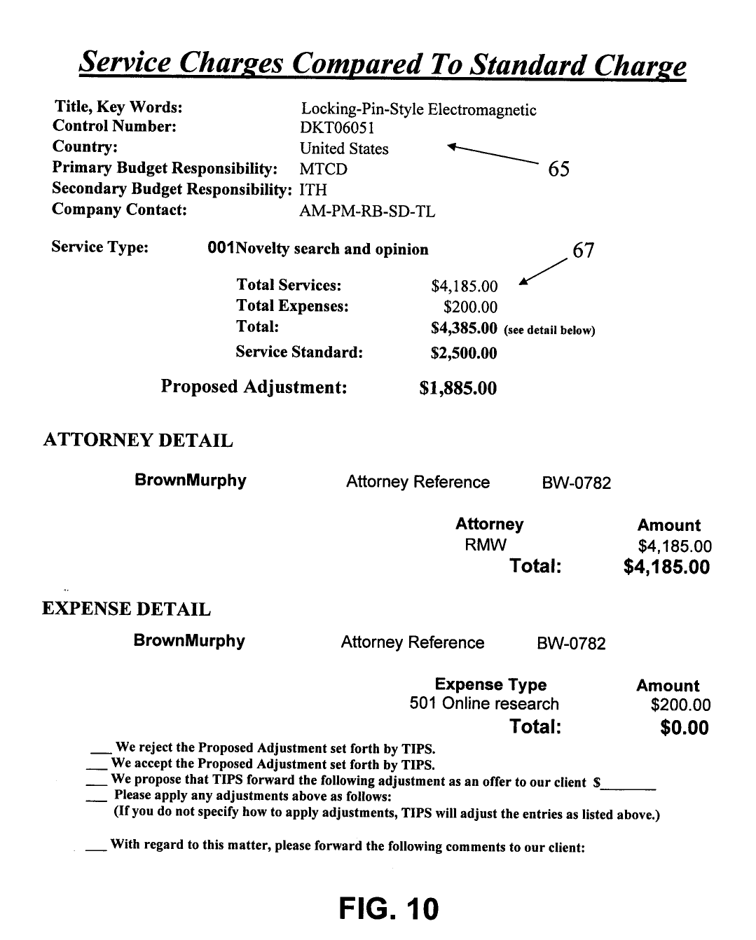

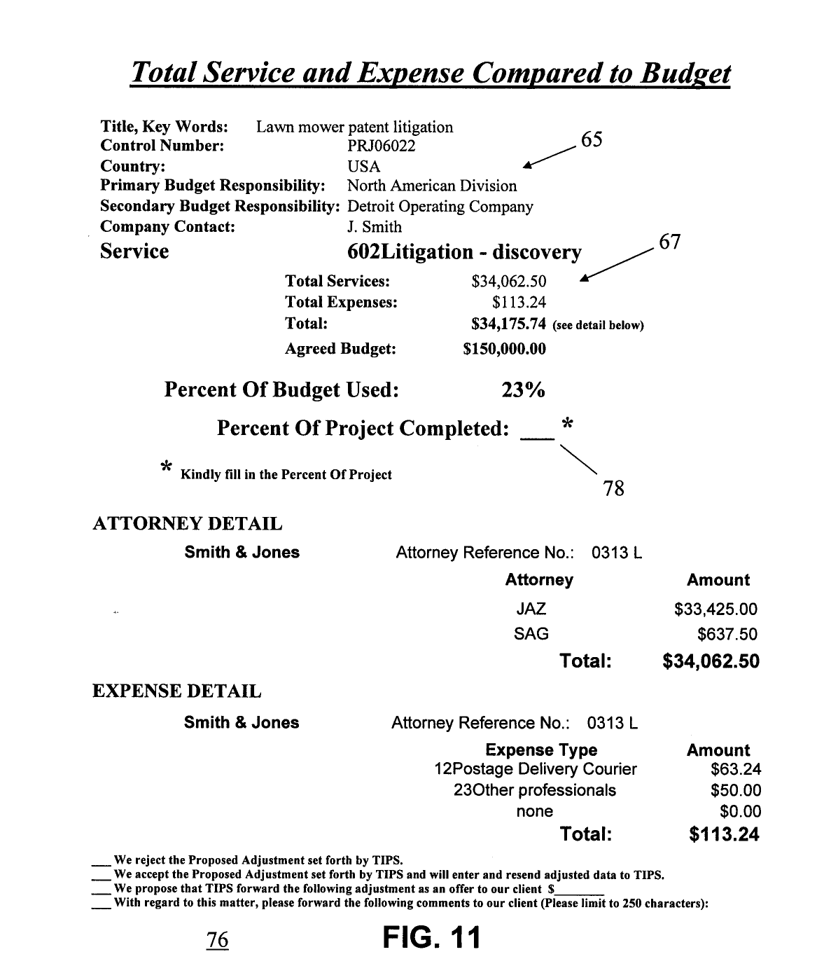

As further shown in FIGS. 1C and 1D, if the adjustment process is completed or the legal service provider chose not make any adjustments due to the results of test option 58, a user of the analysis database 16 can select comparison options 70. This option analyzes 72 the data to determine if the total cumulative attorney service charges and/or expense charges have exceeded standard charges and/or a budget. If a standard or a budget has been exceeded, a report is generated 62 that includes selected legal matter data 65 and invoice data 67 identifying the applicable legal matter and excessive charges. An exemplary report 74 is shown in FIG. 10. As shown in FIG. 11, if a legal matter has a budget, a report 76 can be generated that indicates the percentage of the budget that has already been used. Note, in one embodiment, the report 76 shown in FIG. 11 requires the legal service provider to indicate 78 what percentage of legal matter or “project” has been completed. The following is a list that includes, but is not limited to the types of analyses conducted by conventional queries and techniques in the database of the present invention:

Analysis to determine if total costs on a legal matter exceed a budget. If total costs for a legal matter exceed a budget or a percentage of that budget, a budget has been violated and selected legal matter and invoice data is reported.

Analysis to determine if an expense on a legal matter exceeds an expense standard. If an expense has been charged that exceeds an expense standard, a standard has been violated and selected legal matter and invoice data is reported.

Analysis to determine if total attorney charges for a service type on a legal matter exceed an attorney amount standard. If total attorney charges for a service type on a legal matter exceed a standard, a standard has been violated and selected legal matter and invoice data is reported.

Analysis to determine if total attorney charges and expenses for a service type on a legal matter exceed a service type standard. If expenses and attorney charges exceed the service type standard, a standard has been violated and selected legal matter and invoice data is reported.

Analysis to determine if total attorney charges and expenses for a service type on a legal matter exceed a budget or a percentage of that budget. If expenses and attorney charges exceed the budget, a budget has been violated and selected legal matter and invoice data is reported.

Analysis to determine if total attorney charges and expenses for a legal matter exceed a budget or a percentage of that budget. If expenses and attorney charges exceed the budget, a budget has been violated and selected legal matter and invoice data is reported.

In summary a cost target can be established for attorney charges and/or expenses for one service type that applies to all legal matters, for one service type that applies to one legal matter and for all service types that apply to one legal matter.

Any reports generated 62 as a result of these analyses 72 are sent 62 to the legal service provider who provided the invoice data. In one embodiment of the present invention, the reports include proposed changes or “adjustments” that would place the charges in compliance with the standard charge or budget. The reports also include multiple response options for the legal service provider to choose from indicating how they wish to respond to the report. The legal service provider reviews 66 these reports and determines if adjustments will be made to the invoice data and whether any comments will be provided. If adjustments are made, the legal service provider may indicate 68 how any such adjustment should be applied to the invoice data. Adjustments to the invoice data and comments 68 can then be entered into the database system 10 via the menu 52 shown in FIG. 8A. Adjustments could certainly also be made by the legal service provider in database 14 and the new adjusted data could reentered into the database 16. As shown in FIGS. 1C and 1D, after adjustments are entered, the process is repeated until there are no new reports to be sent to the legal service provider.

Note, in an alternative embodiment shown in FIGS. 1A and 1B, tests conducted under test option 58 and comparisons conducted under comparisons option 70 are performed 25 at the same time under combined option 88. Any reports generated as a result of these analyses are sent to the legal service provider 19 for comments and adjustments in accordance with the present invention.

As shown in FIGS. 1A, 1B, 1C and 1D after the tests, analyses and respective adjustments above are completed, if there are any remaining invoice errors, violations of billing guidelines, or charges that exceed standards or budgets 29 and 82, these reports are reviewed and analyzed by the analytical users of the system 31 and 84. Analytical users of the system enter expert analysis and comments 33 into the database system 10 under the matter identifying codes. Analytical users can also manually review invoices and relevant services for other professional service and invoicing issues 31 and 84. Again, resulting expert analysis and comments are entered 33 into the database 10 either generally or in relation to a specific legal matter. In accordance with the present invention, analytical users can be from an outside service and/or the business. If the analytical user is an outside service, this service may obtain comments and analysis from the business and enter 136 them into the database 16 as well. If the analytical user is the business itself, the business may enter 136 analysis and its comments directly into the system 10.

Ultimately, comments and analysis from the legal service provider, the business, the analytical users and/or other users are entered into the database system of the present invention under identifying codes. Therefore, the database system 10 of the present invention can directly link the comments, analysis and invoice data to the applicable legal service provider, legal matter or legal asset data. As such, periodic and historic reports 41, 43, 45, 47 and 49 can then be generated by the database system 10 that include related legal matter and invoice data, and may also include related analysis and comments. As shown in FIGS. 1A and 1B, these reports can include any comments and analysis provided during the adjustment process by the legal service provider, an analytical user of the system or a business subscribing to the system.

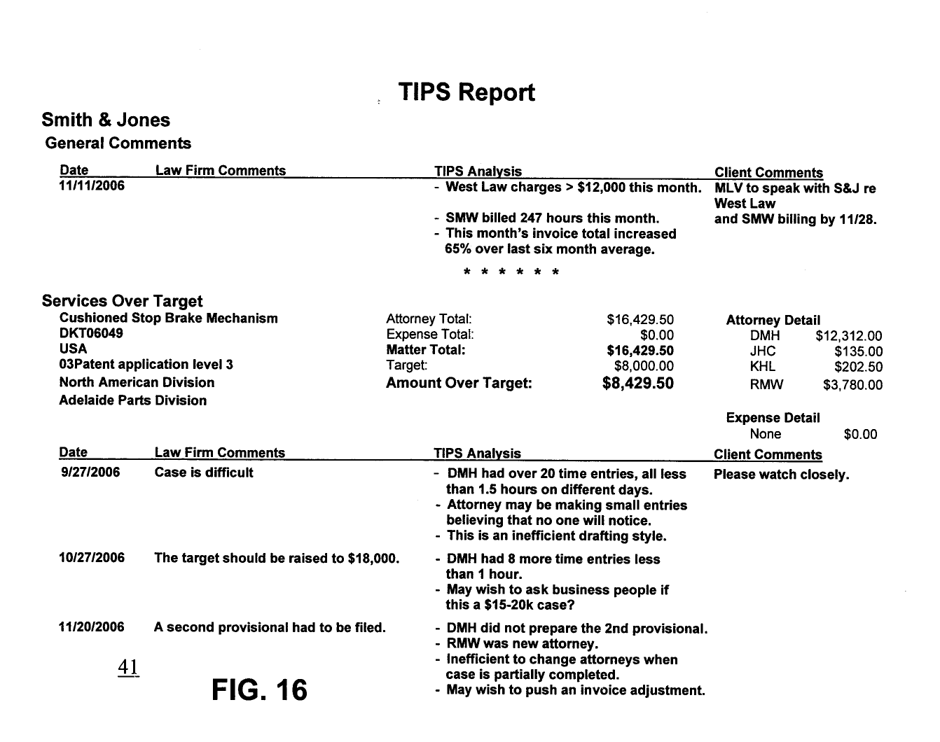

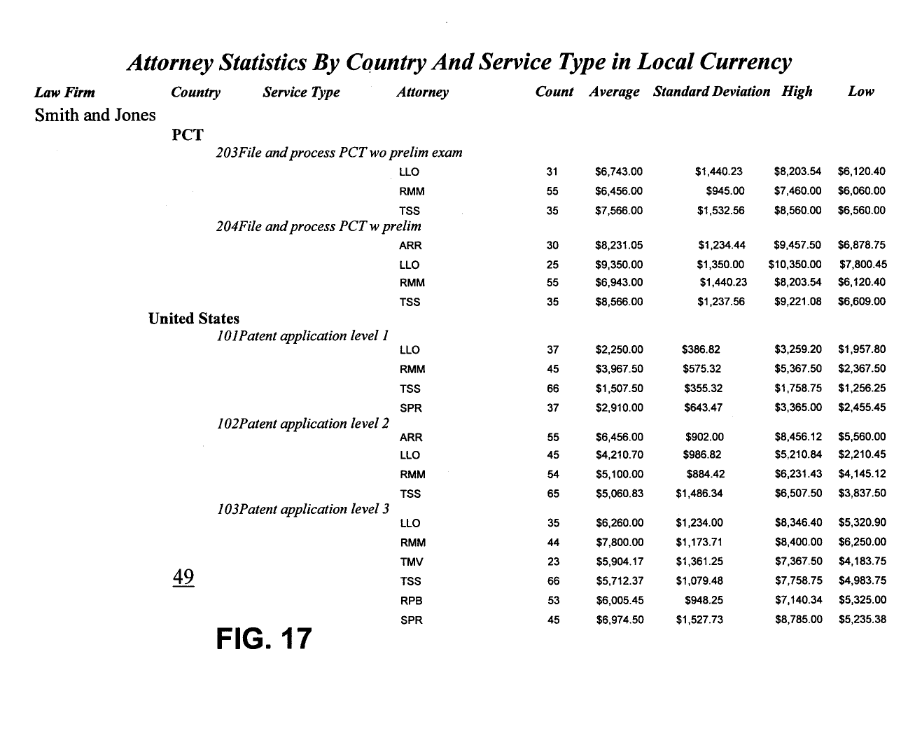

These types of business friendly reports include but are not limited to expense reports, budget reports, cost tracking reports, monthly invoice reports, monthly and annual expense reports and the like. Each of these reports can include or be sorted by any of the fields in the database as mentioned herein. More specifically these reports include historical legal service provider performance review reports 41 shown in FIG. 16, invoice and legal matter data reports and/or files for importing into an accounting system 43, final invoice reports in a common format specified by the business 45 as collectively shown in FIGS. 18 and 19, reports on invoice data summed by legal matter and/or business budget data 47 shown in FIGS. 13 and 14 and statistical analysis of legal service provider charges by service type 49 shown in FIG. 17. Such accounting and business reports enable the better tracking and management of legal matters outside the legal department.

In an alternative embodiment of the present invention, a cumulative report of all matters over target or over budget can be generated for a selected legal service provider over a selected period of time. In this report, a business can quickly see how much a specific legal service provider is over target and/or over budget for all legal matters combined, within a selected period.

In the event a business accepts that a legal matter will exceed the standard cost target or budget, the business can specify that it no longer wants to receive reports on that legal matter or that it no longer wants to receive such reports for a specified period. Information can be entered into the database relating to the applicable legal matter, which automatically removes that matter from reports permanently or for a specified period of time.

In one embodiment of the present invention, a spread sheet of selected related invoice data and legal matter data is provided. This spread sheet is in a read only format and can be sorted and filtered by any of the fields in the spread sheet. As such, custom expense reports can be created immediately at a user's desktop. For example, if a user wanted to review all charges by a selected law firm over the last year, this date range and the law firm would be entered into a filter. All data within that date range, relating to that law firm, would meet the criterion and be provided in the filtered spread sheet. The spread sheet could then be sorted by attorney or by service type or by business unit or any other field. A nested sort could also be performed. For example, the total charges by the law firm could be further broken down by attorney first and then by service type. After the desired data has been located, it can be copied into another software such as Excel or Word for further analysis or reporting, respectively.

As shown in FIG. 16, monthly invoice and performance review reports 41 neatly summarize the historical invoice data for each legal matter in question, along with all relevant comments and analysis. In other words, reports generated by the database of the present invention can include invoice data from any invoice relating to the open issue, no matter when the invoice data was entered into the system. Likewise, such reports can also include related comments and analysis, no matter when they were entered into the system. Hence, these detailed reports 41 enable a manager to review cumulative total charges and historical comments and analysis for each open issue. This enables a business to quickly manage the underlying costs and legal services. The reports can be readily used to conduct monthly invoice reviews for all legal service providers, where cost and/or service issues require immediate attention. Reports can also be generated to conduct periodic performance reviews on specific legal service providers. As such, a user of the system of the present invention can proactively manage both invoice charges and the performance of legal service providers with documented specificity.

With regard to monthly invoice review reports, the business may review 37 and 86 the report, contact the legal service provider and negotiate any final adjustments as shown in FIGS. 1A, 1B, 1C and 1D. After reviewing the reports, the business indicates if there are any final adjustments to the invoice data and any such adjustments or comments are entered 13 and 14 into the database system 10 as shown in FIGS. 1A, 1B 1C and 1D. Again, adjustments could certainly also be made by the legal service provider in database 14 and the new adjusted data could reentered into the database 16. Under option 61 of the menu 52 shown in FIG. 8A, a report can be generated to check and confirm that all adjustments were properly entered 80. After any final adjustments by the business have been entered, the invoices being reviewed are given an approval date.

In another embodiment of the present invention, if there are invoicing errors, violations of billing guidelines or charges exceeding standards or budgets, the business may choose to rigidly enforce the proposed adjustments set forth above. For example, if there is a violation of billing guidelines, the business may desire that the database automatically enter an adjustment to put the applicable invoice data in compliance with the applicable guidelines. Likewise, if charges exceed a standard charge, the business may desire that the database automatically enter an adjustment to put the applicable invoice data in compliance with the standard.

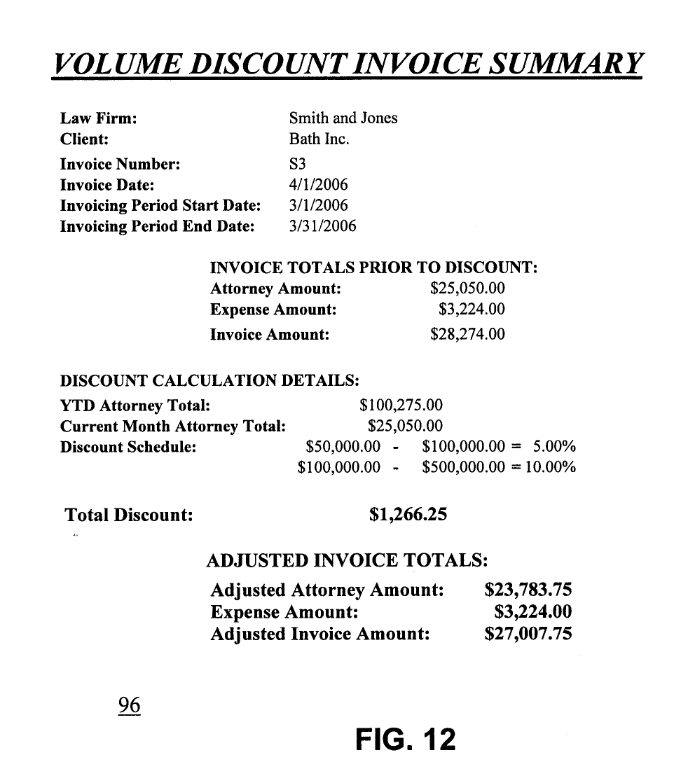

As shown in FIGS. 1A, 1B, 1C and 1D after final adjustments are entered 13 and 14 under option 80 into the database system 10, a final invoice report can be generated and approved for payment under option 90 of the menu 52 shown in FIG. 8B. If there are any discounts to be applied to the invoice, for example a volume or flat rate discount, the analysis database calculates 92 the applicable discount and then generates 94 invoice reports, which include the discount. An exemplary invoice report 96 including a volume discount is shown in FIG. 12.

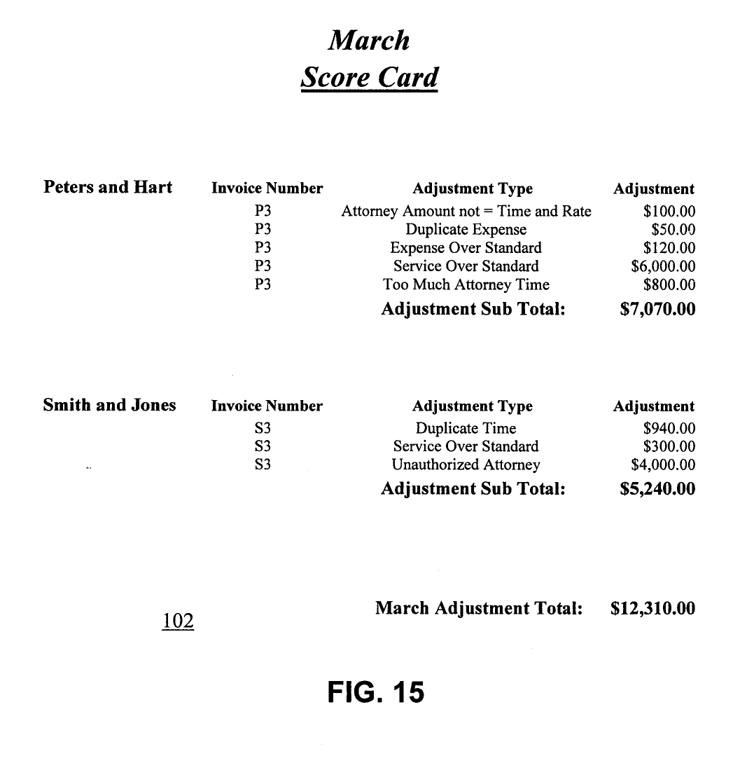

By selecting various report options 98 from the menu 52 shown in FIG. 8C, standardized reports 41, 43, 45, 47 and 49 as well as customized reports can also be generated 100 by the analysis database 16 after final adjustments have been entered. The business report 102 shown in FIG. 15 includes a list of all adjustments to the invoice data for each invoice processed during a selected period of time. FIG. 14 illustrates another business report 24 that generates a list of all legal matters that incurred invoice charges during a selected period of time. In accordance with the present invention, this report 24 can be further categorized by other legal matter data such as business budget data. The report 24 shown in FIG. 14 categorizes or groups monthly legal matter cost totals by a primary budget reference and secondary budget reference. This report 24 allows a person with responsibility for this budget to review the monthly legal costs on each matter.

As shown in FIG. 8C a number of reports can be generated in accordance with the present invention by selecting report options 98. The report 22 shown in FIG. 13 summarizes cost totals for all legal matters relating to business budgets. In one embodiment of the present invention, both a monthly and a year to date legal matter total is provided and grouped by business budget. An invoice report to the business from the outside service can also be generated under report options 98 of the menu 52 shown in FIG. 8C.

As shown in FIG. 17, the database further provides the business with a report 49 showing the average charges for the services performed by different legal service providers, enabling an analytical user to review both the quality of the legal services and the average cost of such services to identify the most cost efficient providers. In one embodiment of the present invention, the system 10 performs a statistical analysis on invoice data from selected legal service providers. The service providers' total charges for individual legal matters relating to selected service types are analyzed. As shown in FIG. 17, the statistical analysis for the selected service type includes, but is not limited to calculating an average matter cost, a high matter cost, a low matter cost, a median matter cost, a standard deviation for matter costs and a count of matters analyzed. In one embodiment of the present invention, the system can also perform a statistical analysis on the cost of preparing a patent application relative to the number of pages in the patent specification, the number of claims and/or the number of sheets of drawings. The reports generated from any such statistical analyses enable a business to compare charges between one legal service provider and another. With this comparison available, quality of the legal service can be reviewed and the best value for legal services can be determined. These and other reports can be generated by the database system 10 in accordance with the present invention.

As a result of using the database system of the present invention, comments, analysis, invoice data and legal matter data are entered into the database system. This electronic data can be imported into, or linked with, other software used by the business, including but not limited to internal and external auditing, project management, accounting, accounts payable, payments in foreign currency, inter-company charges, as well as business and legal matter management software. For example, selected invoice data and legal matter data 43 can be uploaded from the database of the present invention into “e-billing” accounting and/or auditing software to accommodate accounting requests including but not limited to the calculation of inter-company charges, audit requests and the like. This data 43 can also be used to generate check requests and accounts payable reports. Hence, the flow of data is electronic, which speeds up the process and greatly reduces chances of data re-entry error.

As such, the legal, accounting, and business departments are no longer independent islands of information and tasks. Rather they are linked by the database system of the present invention, which manages the flow of legal matter data and invoice data from receipt of the legal invoice through payment. The resources necessary to manage legal matters are reduced, the flow of information is improved and the time required to review, manage and make payments is reduced. In addition, invoice and legal matter data are entered into the database system of the present invention only once, in a common format specified by the business rather than by a legal service provider.

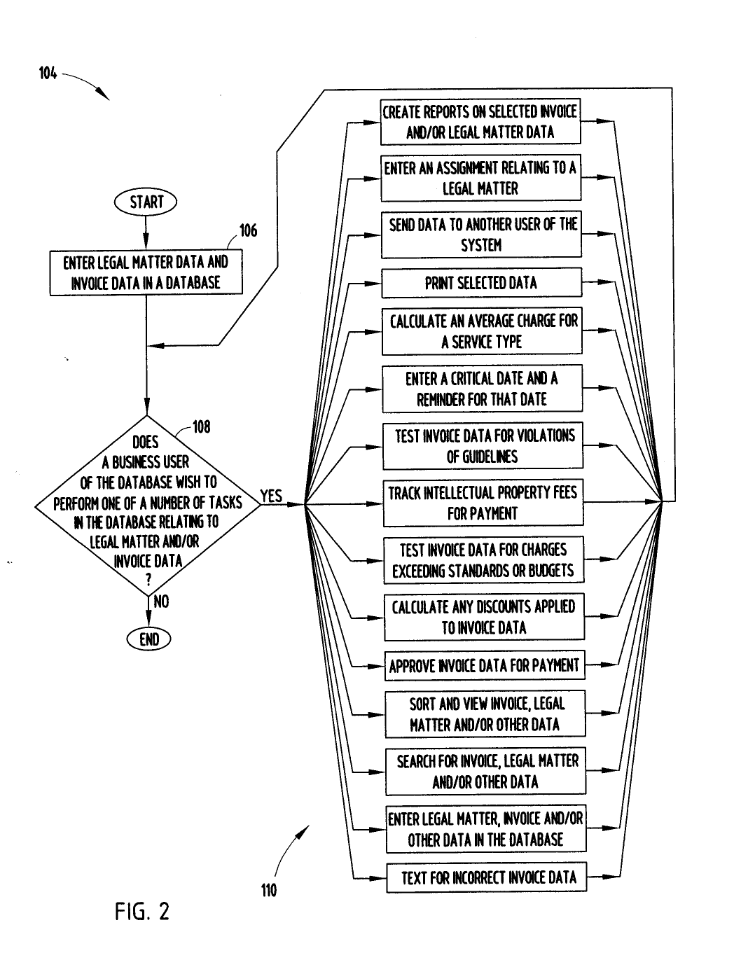

In addition to assisting a business manage its legal invoices and costs, a system 104 incorporated into the database system 10 in accordance with the present invention, can also assist businesses to organize and manage their legal matters and assets. As shown in FIG. 2, after legal matter data has been entered 106 into the system 104, a business user can perform 108 a number of additional and related tasks 110, which relate to the legal matter and invoice data. In addition to generating the reports listed above, additional and related tasks 110 include, but are not limited to, the following.

Enter a work assignment relating to a legal matter such that the assignment is recorded and stored. Send data to another user of the system, for example, sending a work assignment along with applicable legal matter data to a user of the system. Print selected data from the system, for example, print a work assignment and any applicable legal matter data for your files. Calculate an average charge for an expense type or service type to determine the most cost effective legal service provider of that expense or service type. Enter a critical date and a reminder for that date so that you are reminded of a due date for a necessary action, for example, entering a due date and a reminder for a deadline to renew a contract. Track intellectual property fees for payment, for example, a reminder to pay a patent maintenance fee or the like. Sort and view data, for example, enter a read only datasheet view of the database where a user can organize columns of data in a desired order and then sort those columns to view selected data records grouped by the data being sorted. Search for selected data, for example search for a certain legal matter by using the Microsoft Access 2003 find function and entering a key word or number. Enter additional data, for example, enter a new task, critical date, legal matter data or the like.

As set forth above, the present invention provides a comprehensive database system for organizing and managing legal assets and matters, as well as all of the associated legal service services, invoices and costs.

These and other embodiments of the present invention shall not be limited by the appended claims.

The invention claimed is:

1. A database system for managing intellectual property matters and associated legal costs comprising: an intellectual property matter management portion of said database system, said matter management portion adapted to store, organize and docket intellectual property matter data, and to calculate payments relating to said intellectual property matters, and an invoice management portion of said database system in relational communication with said matter management portion of said database system, said invoice management portion adapted to receive and perform analysis on invoice data relating to said intellectual property matter data to determine if charges for a legal service relating to one of said intellectual property matters have exceeded a cost target for said legal service, said database system adapted to provide reports that include selected intellectual property matter data and selected invoice data, which both relate to said legal service.

2. The database system of claim 1 wherein said invoice management portion is adapted to perform statistical analysis on said charges relating to a plurality of said intellectual property matters for selected attorneys, whereby said charges by said selected attorneys can be compared.

3. The database system of claim 1 wherein a user of said database system performs a review of said reports and enters input from said review into said database system.

4. The database system of claim 1 wherein said database system provides selected invoice data and selected intellectual property matter data relating thereto in an electronic format that can be imported into an accounting software system for performing accounting functions on said data, said accounting functions including at least one function from a group comprising calculation of check requests, calculation of inter-company charges, calculation of payments in foreign currency and internal auditing of said charges.

5. The database system of claim 1 wherein said intellectual property matter data includes budget data that identifies a budget within said business that is responsible for paying said charges relating to said intellectual property matter.

6. The database system of claim 1 wherein said database system performs said analysis on invoice data relating to said intellectual property matter data to determine if there are errors or violations of billing guidelines in said invoice data.

7. A system for comparing and managing intellectual property costs comprising: a database adapted to store, relate and analyze business legal matter data relating to legal matters and legal service provider invoice data relating to fees and expenses, said system relates portions of said legal matter data and portions of said invoice data to a plurality of service types, said service types comprising at least one patent application preparation service type and at least one patent application processing service type, said at least one patent application preparation service type is defined to include all services relating to preparing a patent application for filing and said at least one patent application processing service type is defined to include all services relating to filing and processing said patent application through a final disposition of the patent application, said system calculates a sum of all said fees and expenses for one said service type relating to one of said legal matters and compares said sum to a standard for said one service type such that when said sum exceeds said service type standard, said system identifies selected legal matter data and invoice data.

8. The system of claim 6 wherein said standard includes at least one standard from a group comprising a cost target for one of said service types that applies to all said legal matters, a cost target for a one of said service types that applies to one of said legal matters and a cost target for all of said service types that applies to one of said legal matters.

9. The system of claim 6 wherein said final disposition of the patent application is defined as a patent application where all said services relating to said patent application processing service type are completed such that said patent application can be described as one of a group comprising an issued United States patent including any post issuance corrections, a lapsed United States provisional application, a granted utility patent outside the United States where any applicable opposition proceedings have been completed, a completed European patent application immediately prior to going national into various contracting European Patent Office countries, a national application that originated from the European Patent Office where all translations and proceedings before the national patent office are completed, and a PCT patent application immediately prior to going national into various contracting PCT countries.

10. The system of claim 6 wherein said system is adapted to perform a statistical analysis on said sums for said service types performed by said legal service providers, said statistical analysis including at least one calculation from the group comprising an average sum, a high sum, a low sum, a median sum, a standard deviation for said sums, a count of sums, an average sum per page in a patent specification, an average sum per number of claims in a patent, and an average sum per sheet of drawings in a patent.

11. The system of claim 6 wherein said at least one patent application preparation service type is a plurality of said service types, each of which represent different levels of expense in preparing the patent application.

12. A computer assisted method for managing legal services and all associated costs comprising the steps of:
a. entering service types and cost targets for said service types into a database system;
b. entering legal matter data into said database system relating to a plurality of legal matters;
c. entering legal service provider invoice data relating to said service types and said legal matter data into the database system, said invoice data including charge data;
d. using said database system to determine if said invoice data has been correctly related to said legal matter data and said service types;
e. correcting any said invoice data that is identified by said determination;
f. using said database system to sum all said charge data relating to one of said service types, which relates to one of said legal matters;
g. using said database system to compare said sum to said cost target for said one service type;
h. using said database system to report selected legal matter data and selected invoice data relating to any said sum that exceeds said cost target for said one service type;
i. providing legal service providers with at least a portion of said selected legal matter and invoice data such that said legal service providers can provide comments on said selected data;
j. entering legal service provider comments relating to said selected legal matter and invoice data into said database system;
k. providing an analytical user of said database system with at least a portion of said related comments and relevant legal matter and invoice data such that said analytical user can provide analysis relating to said selected legal matter and invoice data and said related comments;
l. entering analytical user analysis relating to said selected legal matter and invoice data into said database system; and
m. using the database system to compile reports that summarize said selected legal matter and invoice data, said related comments and said related analysis.

13. The computer assisted method of claim 10 wherein said method further comprises the step of testing said invoice data for incorrect matter reference numbers, countries, service types and expense types that do not correctly relate to legal matter data and reporting said incorrect matter reference numbers, countries, service types and expense types.

14. The computer assisted method of claim 10 wherein said method further comprises the step comparing said sum for a standard service type against a standard cost target and said sum for a unique service type against a unique cost target.

15. The computer assisted method of claim 10 wherein said method further comprises the step of said analytical user reviewing the applicable legal service provider work quality relating to the selected legal matter and invoice data to identify and report legal service provider inefficiencies.

16. The computer assisted method of claim 10 wherein said method further comprises the step of said analytical user reviewing the applicable legal service provider invoices relating to the selected legal matter and invoice data to identify and report legal service provider billing issues.

17. The computer assisted method of claim 10 wherein said step of using the database system to compile reports that summarize said selected legal matter and invoice data and said related comments and analysis is completed on a monthly basis for all legal service provider invoices received on said monthly basis.

18. The computer assisted method of claim 17 wherein said step further comprises the step of providing said reports on said monthly basis with historical comments and analysis, previously entered into the database system in a prior month, said historical comments and analysis relating to said selected legal matter and invoice data.

19. The computer assisted method of claim 10 wherein said step of using the database system to compile reports that summarize said selected legal matter and invoice data and said related comments and analysis is compiled for a selected legal service provider over a selected period of time for generating performance review reports on said selected legal service provider.

20. The computer assisted method of claim 10 wherein said method further comprises the step of using said database system to test said invoice data, said test including at least one test from a group comprising testing for too many attorney hours in one day, testing for an unauthorized attorney, testing for expenses under an unauthorized legal matter, testing for services under an unauthorized legal matter, testing for duplicate expense entries, testing for duplicate attorney time entries, testing for the invoice total to equal all individual expense and attorney time entries, testing for each attorney time entry to equal the attorney rate multiplied by the attorney time, testing for attorney time entries occurring after a legal matter has been stopped, testing for expense entries occurring after a legal matter has been stopped, testing for an attorney, testing for charges by an attorney that has been terminated, testing for charges by a non-team attorney, testing for a first charge on a legal matter occurring a period of time after said legal matter was initiated and testing for correct exchange rates on foreign currency.
